(19) United States
(12) Patent Application Publication
(10) Pub. No.: US 2011/0026509 A1
(43) Pub. Date: Feb. 3, 2011

(54) WIRELESS COMMUNICATION APPARATUS

(76) Inventor: Akio Tanaka, Tokyo (JP)

Correspondence Address: Mr. Jackson Chen, 6535 N. STATE HWY 161, IRVING, TX, 75039, US

(21) Appl. No.: 12/920,919

(22) PCT Filed: Apr. 17, 2009
(86) PCT No.: PCT/JP2009/057789

§ 371 Date: Sep. 3, 2010

(30) Foreign Application Priority Data
Apr. 25, 2008 (JP) 2008-115389

(51) Int. Cl. H04W 88/02

(52) U.S. Cl. 370/338

(57) ABSTRACT

A wireless communication apparatus includes: a first local generator that generates a first local frequency arranged around a center frequency of a band group; a first down converter that receives a supply of a local signal from the first local generator; and a complex filter that quickly changes filter wave characteristics according to frequency hopping. A control to set the hopping complex filter to all-pass characteristics in wireless communication in a band crossing a local frequency among the bands for hopping and in wireless communication for simultaneously using the bands and to set the hopping complex filter to one side frequency suppression characteristics in other wireless communications is performed.

### TECHNICAL FIELD

The present invention relates to a wireless communication apparatus that performs wireless communication while quickly hopping between bands of ultra wideband.

### BACKGROUND ART

Fast data transmission performance is required in wireless communication of recent years, and for example, a 54 Mbps communication speed is realized in a wireless LAN apparatus compliant with IEEE 802.11a. Furthermore, UWB (Ultra Wide Band) is formulated by IEEE 802.15.TG3a as a technique for realizing a communication speed of a class faster than 480 Mbps.

In a wireless communication apparatus that realizes such fast communication, occupied frequency bands are significantly wide due to Shannon's law. For example, a wide frequency band from 3.1 GHz to 10.6 GHz is used in a communication apparatus (hereinafter, called “UWB wireless communication apparatus”) that realizes the UWB. There has not been a wireless communication apparatus that requires a frequency band that is three times the frequency of the lower limit.

A basic operation of the UWB wireless communication apparatus is described, for example, in U.S. Patent Application Publication No. 2004/0047285 (hereinafter, called “Patent Document 1”).

The UWB wireless communication apparatus comprises, for example, bands formed by a predetermined (for example, 500 MHz) frequency band used in wireless communication as shown in FIG. 1(a) and transmits and receives user data (hereinafter, called “UWB signal”) by, for example, OFDM (Orthogonal Frequency Division Multiplexing) symbols f1 to f3 while hopping the bands according to a predetermined sequence.

A receiver described in Patent Document 1 implements a direct conversion system for directly converting received wireless (RF: Radio Frequency) signals to baseband signals and generating local signals corresponding to radio frequencies of bands in accordance with the hopping operation (FIG. 1(b)). A mixer uses the corresponding local signals to down-convert the received RF signals to baseband signals of a 500 MHz band, and then an A/D converter at 500 Msps (Mega samples per second) conversion rate converts the signals to digital signals.

Meanwhile, a transmitter described in Patent Document 1 comprises a D/A converter at 500 Msps conversion rate and generates local signals corresponding to the radio frequencies of the bands in accordance with the hopping operation as in the receiver. The mixer then uses the corresponding local signals to up-convert the baseband signals to be transmitted into RF signals.

Another example of related art of the UWB wireless communication apparatus includes a configuration of using a local signal at a fixed frequency and transmitting and receiving a UWB signal hopping between bands, the configuration of which is described in Japanese Laid-Open Patent Publication No. 2006-121439 (hereinafter, called “Patent Document 2”) (see FIGS. 1(c) and 2(c)).

The receiver described in Patent Document 2 quickly applies A/D conversion to an IF (Intermediate Frequency) at 2112 MHz frequency band. In the UWB wireless communication apparatus, the frequency band of the bands is 528 MHz, and A/D conversion is collectively applied to IF signals of three bands (first to third bands). The frequency band of the IF signals after down conversion is −264 to +1320 MHz, and the IF signal of the first band exists around DC (direct current). Meanwhile, the IF signal of the second band exists around 528 MHz, and the IF signal of the third band exists around 1056 MHz. Therefore, the receiver described in Patent Document 2 performs down conversion again in digital signal processing after the A/D conversion.

Furthermore, another example of related art of the wireless communication apparatus includes an example of using a complex filter to form a low IF wireless communication apparatus with relatively low frequency of IF signal, the example of which is described in Japanese Laid-Open Patent Publication No. 2006-121546 (hereinafter called “Patent Document 3”) (see FIG. 2(a)). A so-called multiband generator that needs to generate local signals of the bands is used for a synthesizer that is included in the wireless communication apparatus and that generates the local signals. The wireless communication apparatus described in Patent Document 3 includes such a multiband generator to realize the low IF wireless communication apparatus in the UWB wireless communication apparatus.

U.S. Patent Application Publication No. 2006/0051038 (hereinafter, called “Patent Document 4”) describes an example of configuration of a receiver that uses a hopping filter to demultiplex a multicarrier (see FIG. 2(b)). In Patent Document 4, an orthogonal modulator is arranged in a latter stage of the hopping filter. The hopping filter described in Patent Document 4 is not a complex filter but is configured to switch a filter bank in an RF area to separate the multicarrier.

Furthermore, a UWB wireless communication apparatus examining an interfering wave (blocker) countermeasure is described, for example, in Japanese Laid-Open Patent Publication No. 2004-096141A (hereinafter, called “Patent Document 5”) (see FIG. 2(d)). In Patent Document 5, the conversion rate of an A/D converter (ADC) is changed to observe a change in an error rate (S/N or C/N), and a power calculator is used to determine whether there is an influence of the interfering wave. If there is an influence of the interfering wave, the UWB wireless communication apparatus described in Patent Document 5 handles the influence by increasing the conversion rate of the A/D converter.

The UWB wireless communication apparatuses described in Patent Documents 1 and 2 have the following problems.

A first problem is that the scale of circuits that generate local signals and power consumption is large.

The receiver described in Patent Document 1 needs to generate local signals corresponding to the radio frequency of the hopping destination within intervals of about 9.5 ns. A PLL (Phase Locked Loop) circuit is usually used to generate frequency signals, and the PLL circuit requires time of about several μ seconds to lock at a desired frequency. Therefore, to switch the frequency of the local signals at several ns, a multiplicity of SSB (Single Side Band amplitude modulation) mixers or dividers need to be used to combine the local signals for the bands. As a result, the circuit area and power consumption are significantly large. There has not been an operation, in which the frequency quickly hops, in conventional wireless communication apparatuses.

The configuration described in Patent Document 2 also has a problem in which power consumption is high. As described, A/D conversion needs to be quickly applied to the IF signal at 2112 MHz in Patent Document 2. Therefore, a large bias current needs to be supplied to an amplifier, a buffer, and the like to realize a fast switching operation. As a result, power consumption is high. Furthermore, the parasitic capacitance existing in the circuit will quickly charged and discharged, and power consumption is also high in this regard.

A second problem is that unnecessary radiation (spurious signal) is large.

As described, in Patent Document 1, mixers or dividers are used to combine multiple types of frequency signals to generate local signals of the frequencies corresponding to the bands. Therefore, frequency components in the amount of an integral multiple of the frequency signals used for combining emerge in the local signals. Particularly, the input amplitude needs to be large to enlarge the output amplitude in the SSB mixers, and there is a problem in which the enlargement of the input amplitude generates harmonic due to the nonlinearity of the SSB mixers.

The local field though, in which the frequency components inputted to the SSB mixers emerge in the output of the SSB mixers, is also an increase factor of the spurious signal. The problem is also a problem that occurs by use of mixers, which are nonlinear elements, to realize fast hopping, and this problem has not occurred in conventional wireless communication apparatuses.

A third problem is that the removal of the offset of the mixers and amplifiers is difficult. Even if the offset can be removed, the circuit scale (area) of a removing circuit for the removal and power consumption are large.

The problem is caused by a change in the amount of offset of the mixers (down converters) in accordance with the hopping. The mixers used as the down converters multiply the local signals by the signals (local signals) that penetrate into the antenna and the like and that remix, and a phenomenon called self-mixing occurs, in which DC components (offsets) are generated. The self-mixing is frequency-dependent, and the amount of offset changes according to the frequency of the local signal. As described, the frequency of the local signal quickly switches in the UWB wireless communication apparatus, and the offset quickly changes accordingly. Such a problem is also a problem that occurs in realizing fast hopping, and this problem has not occurred in conventional wireless communication apparatuses.

A fourth problem is that the removal of a local leak of the mixer (up converter) of the transmitter is difficult. Even if the local leak can be removed, the circuit scale (area) of the removing circuit for removal and the power consumption are large.

Usually, in an up converter (particularly, an up converter using a MOS transistor), there is a problem of the local leak in which the inputted local signal components are directly outputted. Particularly, the amount of local leak changes depending on the frequency in the UWB wireless communication apparatus.

The amount of local leak equals the sum of local signal components outputted from an RF port caused by the offset voltage that is inputted to a baseband port of the up converter and local signal components that are mixed with transmission signals as a result of the local signal plunging into the RF port of the up converter or into the power amplifier for transmission (local field through phenomenon). Particularly, the latter depends on the frequency, and the amount of local leak changes along with the hopping operation.

Usually, to correct the local leak, a configuration of applying a DC voltage to the baseband port of the up converter to cancel the local leak is implemented. However, in such a configuration, a different DC voltage needs to be quickly and accurately supplied to the baseband port of the up converter every time the band switches. More specifically, realization of a circuit that corrects the local leak is difficult, and the circuit scale (area) and power consumption are, large even if the circuit can be realized. The problem is also a problem caused by the implementation of fast hopping, and this problem has not occurred in conventional wireless communication apparatuses.

The UWB wireless communication apparatuses described in Patent Documents 3 to 5 have the following problems.

As described, a wireless communication apparatus using a complex filter is described in Patent Document 3. In the wireless communication apparatus described in Patent Document 3, a so-called multiband generator that quickly switches local signals needs to be used. Therefore, as in the first problem, there is a problem in which the scale of the circuit that generates the local signals and power consumption are large. In Patent Document 3, local signals of frequencies at band edges are generated to form a low IF wireless communication apparatus, and Patent Document 3 is not designed to reduce the types of local signals.

As described, a wireless communication apparatus using a hopping filter is described in Patent Document 4. Patent Document 4 illustrates an example of a configuration of a hopping bandpass filter used in an RF area, and it is difficult to apply Patent Document 4 to a UWB wireless communication apparatus using a frequency of a GHz band. Even if a hopping bandpass filter that operates at a frequency of a GHz band can be realized, the performance of NF or the like is degraded, and the circuit area becomes large. Therefore, in general, to separate the bands formed by a frequency of a GHz band, a special filter, such as a SAW filter or a ceramic filter, needs to be used.

As described, Patent Document 5 describes a configuration of changing the conversion rate of the A/D converter depending on the level of the interfering wave. Patent Document 5 just illustrates a method for optimizing the conversion rate according to the level of the interfering wave while minimizing power consumption of the A/D converter.

### SUMMARY

Consequently, an object of the present invention is to provide a wireless communication apparatus capable of reducing problems that occur in carrying out fast hopping, the problems including a problem in which the circuit area and power consumption are large, a problem in which the spurious signal is large, and a problem in which the offset and local leak are large.

To attain the object, the exemplary aspect of the present invention provides a wireless communication apparatus that is used in wireless communication and that comprises a band group formed by bands formed by a predetermined frequency band, the wireless communication apparatus handling both wireless communication for hopping the bands in the band group by a predetermined sequence and wireless communication for simultaneously using the bands in the band group, the wireless communication apparatus comprising:

a local generator that generates a local signal equivalent to a center frequency of the band group;

a first down converter that uses the local signal generated by the local generator to down-convert a wireless signal in the band group;

a hopping complex filter that treats the down-converted signal as an input to change a passband; and

a controller that controls the passband of the hopping complex filter, wherein

the controller

controls to set the hopping complex filter to all-pass characteristics in wireless communication in a band crossing a local frequency among the bands for hopping and in wireless communication for simultaneously using the bands and controls to set the hopping complex filter to one side frequency suppression characteristics in other wireless communications.

Alternatively, the exemplary aspect of the present invention provided is a wireless communication apparatus that is used in wireless communication and that comprises a band group formed by bands formed by a predetermined frequency band, the wireless communication apparatus handling both wireless communication for hopping the bands in the band group by a predetermined sequence and wireless communication for simultaneously using the bands in the band group, the wireless communication apparatus comprising:

a local generator that generates a local signal equivalent to a center frequency of the band group;

a first up converter that uses the local signal generated by the local generator to up-convert a wireless signal in the band group;

a hopping complex filter that treats the up-converted signal as an input to change a passband; and

a controller that controls the passband of the hopping complex filter, wherein

the controller

controls to set the hopping complex filter to all-pass characteristics in wireless communication in a band crossing a local frequency among the bands for hopping and in wireless communication for simultaneously using the bands and controls to set the hopping complex filter to one side frequency suppression characteristics in other wireless communications.

### BRIEF DESCRIPTION OF THE DRAWINGS

[FIG. 1]

FIG. 1 is a schematic diagram showing a hopping operation by a wireless communication apparatus described in Patent Documents 1 and 2.

[FIG. 2]

FIG. 2 is a block diagram showing a configuration of a wireless communication apparatus described in Patent Documents 2 to 5.

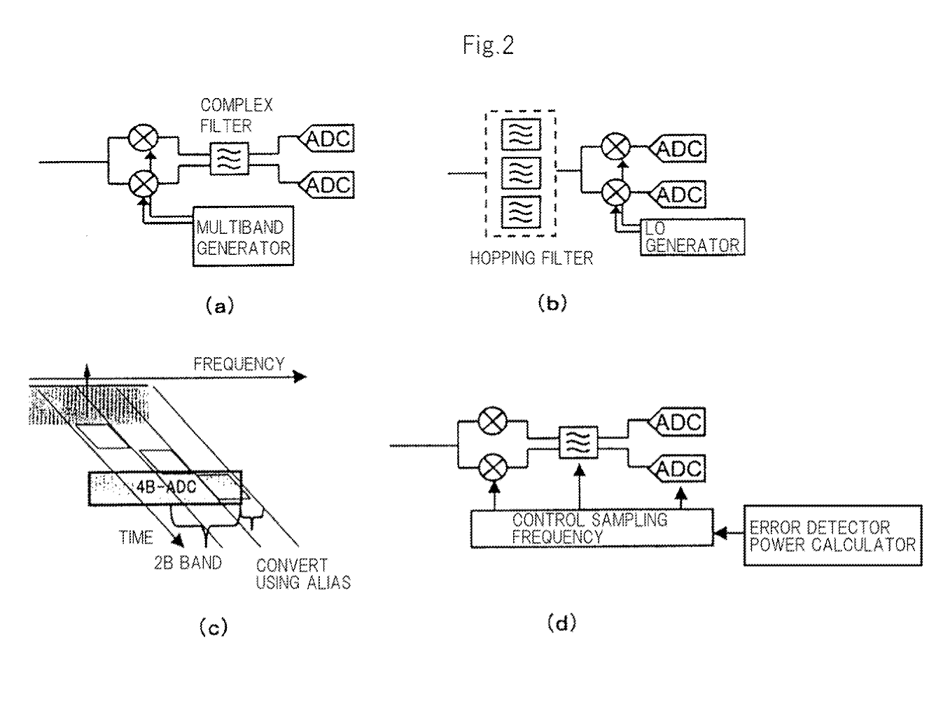

[FIG. 3]

FIG. 3 is a block diagram showing a configuration of a UWB wireless communication apparatus of a first exemplary embodiment.

[FIG. 4]

FIG. 4 is a schematic diagram showing a hopping operation by the UWB wireless communication apparatus shown in FIG. 3.

[FIG. 5]

FIG. 5 is a schematic diagram showing an example of configuration and characteristics of a hopping complex filter.

[FIG. 6]

FIG. 6 is a schematic diagram showing a configuration and an operation of the hopping complex filter used in the present invention.

[FIG. 7]

FIG. 7 is a schematic diagram showing a state of cutting out symbols by the UWB wireless communication apparatus shown in FIG. 3.

[FIG. 8]

FIG. 8 is a block diagram showing a configuration of a UWB wireless communication apparatus of a second exemplary embodiment.

[FIG. 9]

FIG. 9 is a schematic diagram showing a state of cutting out symbols by the UWB wireless communication apparatus shown in FIG. 8.

[FIG. 10]

FIG. 10 is a schematic diagram showing a state of cutting out symbols when an A/D converter shown in FIG. 8 performs an interleaving operation.

[FIG. 11]

FIG. 11 is a schematic diagram showing an operation of the UWB wireless communication apparatus of the second exemplary embodiment.

[FIG. 12]

FIG. 12 is a block diagram showing a configuration of a UWB wireless communication apparatus of a third exemplary embodiment.

[FIG. 13]

FIG. 13 is a circuit diagram showing an example of configuration of a down converter having removal ability of a blocker.

[FIG. 14]

FIG. 14 is a block diagram showing a configuration of a UWB wireless communication apparatus of a fourth exemplary embodiment.

[FIG. 15]

FIG. 15 is a schematic diagram showing a state of cutting out symbols by the UWB wireless communication apparatus shown in FIG. 14.

[FIG. 16]

FIG. 16 is a schematic diagram showing a state of cutting out symbols when a D/A converter shown in FIG. 14 performs an interleaving operation.

[FIG. 17]

FIG. 17 is a block diagram showing a configuration of a UWB wireless communication apparatus of a fifth exemplary embodiment.

[FIG. 18]

FIG. 18 is a schematic diagram showing an example of switching of characteristics by a filter shown in FIG. 17.

[FIG. 19]

FIG. 19 is a block diagram showing a configuration of a UWB wireless communication apparatus of a sixth exemplary embodiment.

[FIG. 20]

FIG. 20 is a schematic diagram showing an example of operation of the UWB wireless communication apparatus shown in FIG. 19.

[FIG. 21]

FIG. 21 is a schematic diagram showing another example of operation of the UWB wireless communication apparatus shown in FIG. 19.

[FIG. 22]

FIG. 22 is a flow chart showing a processing procedure of the UWB wireless communication apparatus of the sixth exemplary embodiment.

[FIG. 23]

FIG. 23 is a flow chart showing a processing procedure of the UWB wireless communication apparatus of the sixth exemplary embodiment.

[FIG. 24]

FIG. 24 is a block diagram showing a configuration of the UWB wireless communication apparatus of the sixth exemplary embodiment.

[FIG. 25]

FIG. 25 is a chart showing an example of a wireless communication apparatus using a hopping complex filter that can handle various modes.

[FIG. 26]

FIG. 26 is a schematic diagram showing a configuration and an example of operation of a UWB wireless communication apparatus of a seventh exemplary embodiment.

[FIG. 27]

FIG. 27 is a block diagram showing another configuration and example of configuration of the UWB wireless communication apparatus of the seventh exemplary embodiment.

[FIG. 28]

FIG. 28 is a block diagram showing another configuration and example of operation of the UWB wireless communication apparatus of the seventh exemplary embodiment.

[FIG. 29]

FIG. 29 is a block diagram showing another configuration and example of operation of the UWB wireless communication apparatus of the seventh exemplary embodiment.

[FIG. 30]

FIG. 30 is a chart collectively showing settings of the wireless communication apparatus when the modes shown in FIG. 25 are executed.

[FIG. 31]

FIG. 31 is a flow chart showing a processing procedure of the UWB wireless communication apparatus of the seventh exemplary embodiment.

[FIG. 32]

FIG. 32 is a flow chart showing a processing procedure of the UWB wireless communication apparatus of the seventh exemplary embodiment.

### EXEMPLARY EMBODIMENT

The present invention will be described next with reference to the drawings.

### First Exemplary Embodiment

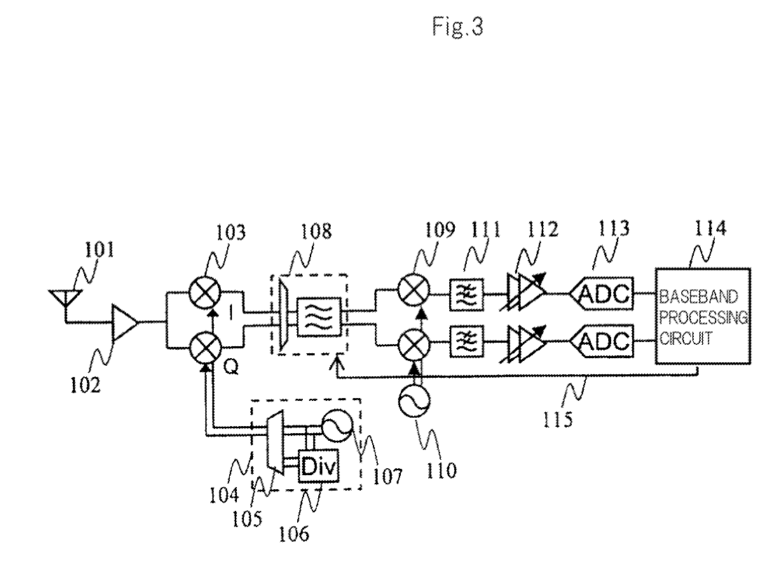

FIG. 3 is a block diagram showing a configuration of a wireless communication apparatus of a first exemplary embodiment. In the first exemplary embodiment, an example of a receiver that receives a UWB signal included in the wireless communication apparatus will be illustrated.

As shown in FIG. 3, the receiver of the first exemplary embodiment comprises reception antenna 101, low noise amplifier (LNA) 102, first down converter 103, first local generator 104, hopping complex filter 108, second down converter 109, second local generator 110, low-pass filter (LPF) 111, variable gain amplifier (VGA) 112, A/D converter 113, and baseband processing circuit 114. First local generator 104 comprises voltage control oscillator (VCO) 107, divider 106, and selector 105.

First, first local generator 104 shown in FIG. 3 will be described.

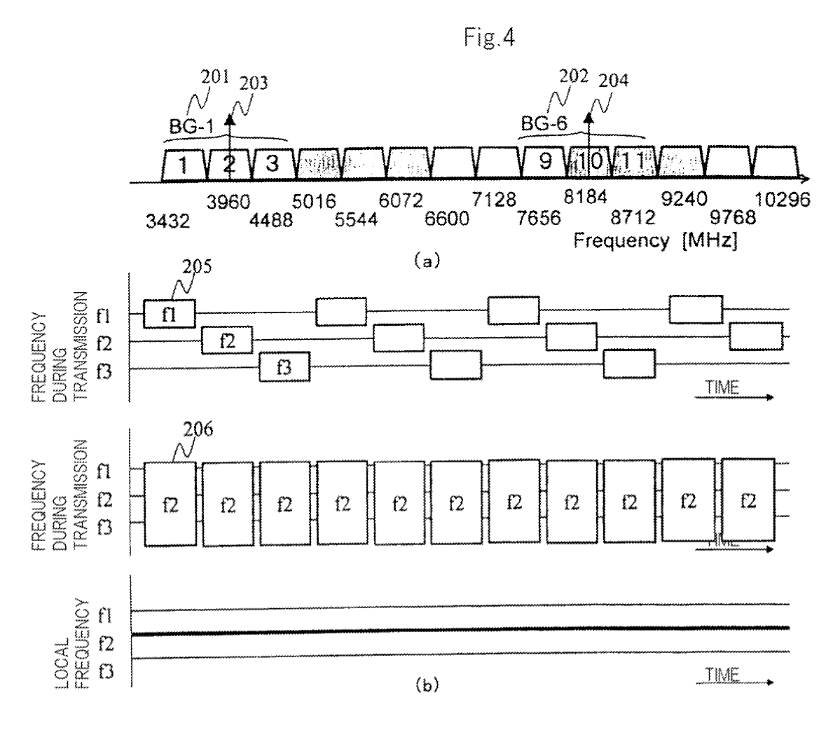

In the UWB wireless communication apparatus, UWB signals are transmitted and received by the band group formed by three bands. As shown in FIG. 4(b), hopping of frequency is carried out between three bands in the band group.

FIG. 4(b) illustrates an example of hopping in the order of f1, f2, and f3. There are seven types of sequences of hopping, and selective use of different types of sequences allows wireless communication with UWB wireless communication apparatuses existing in the same communication area (for example, see High Rate Ultra Wideband PHY and MAC Standard, ECMA-368).

Hereinafter, an operation of a receiver will be described with an example of using first band group 201 shown in FIG. 4(a).

First local generator 104 outputs 3960 MHz which is the center frequency of the first band group. Since first band group 201 comprises a first band, a second band, and a third band, 3960 MHz is the center frequency of the second band.

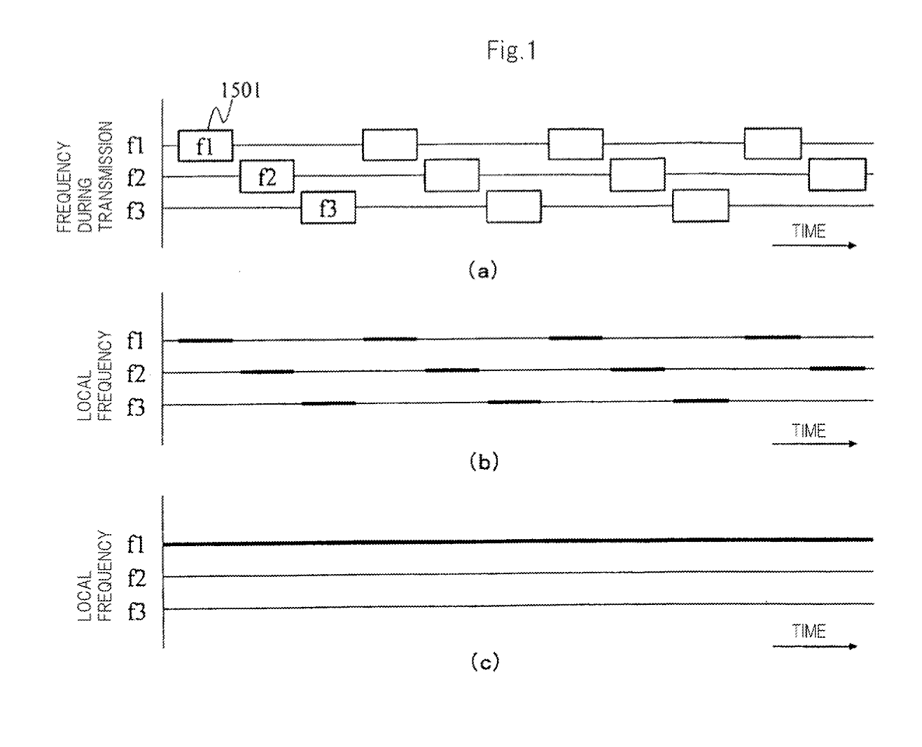

In the UWB wireless communication apparatus of related art, the frequency of the local signal is switched as shown in FIG. 1(b) in accordance with the hopping operation as described above. In the exemplary embodiment, as shown in FIG. 4(b), the frequency of the local signal is fixed at the center frequency of the band group without switching the frequency in accordance with the hopping operation. However, when a different band group is used, the frequency of the local signal is changed to the center frequency of the band group. In the UWB technique, fast performance is not required in the switching of the band group. For example, when a change is made from first band group (BG-1) 201 to sixth band group (BG-6) 202 shown in FIG. 4(a), first local generator 104 changes the output frequency from 3960 MHz, which is the center frequency of first band group 201, to 8184 MHz, which is the center frequency of sixth band group 202. The change speed of frequency may be sufficiently slower than several μ seconds necessary for VCO to lock at the frequency after the change.

Although 3960 MHz, which is the center frequency of first band group 201, and 8184 MHz, which is the center frequency of sixth band group 202, are not in a relationship of integral multiple, 8284 MHz is about twice as large as 3960 MHz. Therefore, if first local generator 104 comprises a ½ divider, local signals corresponding to the center frequencies of first band group 201 and sixth band group 202 can be generated just by slightly changing the oscillation frequency of VCO 107. In that case, VCO 107 can be locked again at a required frequency after changing the division ratio or the oscillation frequency.

First local generator 104 shown in FIG. 3 is an example of a circuit, in which VCO 107 generates a frequency around 8000 MHz, and divider 106 halves the output frequency of VCO 107. Selector 105 selects an output signal of divider 106 if the first band group is received and selects an output signal of VCO 107 if the sixth band group is received. In this case, VCO 107 can include a tuning range with a sufficient margin for various change factors, such as processes, power supply voltage, and ambient temperature, within a range from 7920 MHz, which is a frequency twice as large as the center frequency of the first band group, to 8184 MHz, which is the center frequency of the sixth band group.

Although an example of generating local signals used in the first band group and the sixth band group is illustrated in the description, changing the configuration of the oscillator or the divider allows first local generator 104 shown in FIG. 3 to generate local signals at frequencies corresponding to other band groups. Furthermore, changing the configuration of the oscillator or the divider allows first local generator 104 shown in FIG. 3 to generate local signals corresponding not only to two band groups, but also to more band groups.

Hopping complex filter 108 shown in FIG. 3 will be described next.

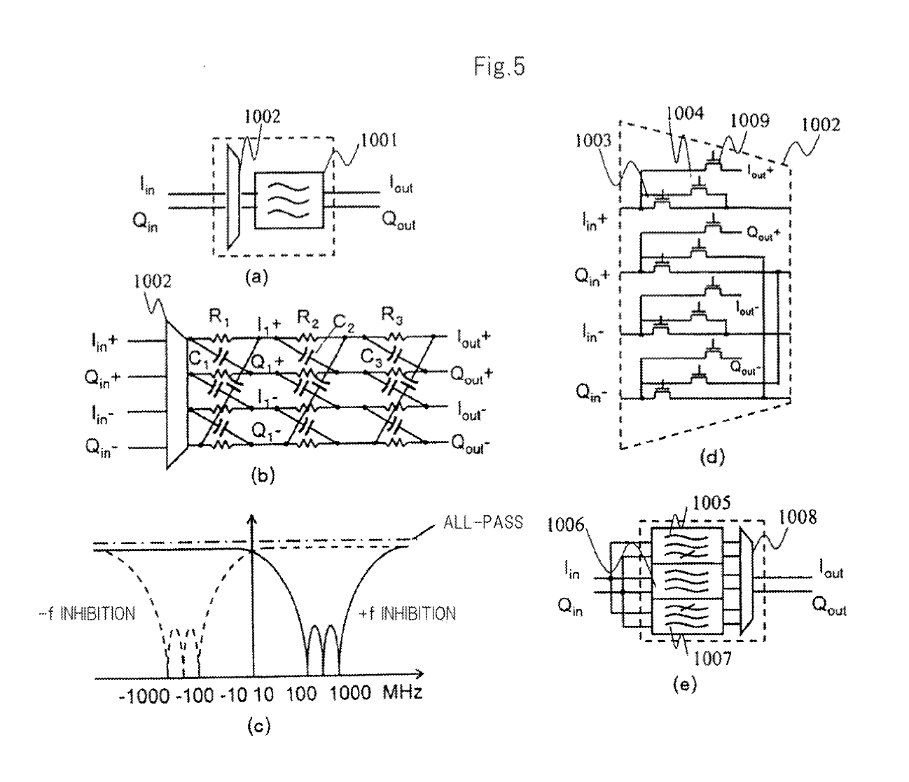

As shown in FIG. 5(a), hopping complex filter 108 comprises polyphase filter 1001 and selector 1002 and can quickly switch filter wave characteristics. For example, a control signal outputted from baseband processing circuit 114 switches the filter wave characteristics. Baseband processing circuit 114 can use, for example, information stored in a preamble of a received UWB signal to establish synchronization and determine switch timing of the filter wave characteristics.

As shown in FIG. 5(b), polyphase filter 1001 has a configuration in which a circuit formed by four resistors and four capacitors is connected, for example, in series in three stages.

Although not illustrated in FIG. 5(a), normal rotation signals (Iᵢₙ+, Qᵢₙ+) of I signal and Q signal as well as inversion signals (Iᵢₙ−, Qᵢₙ−) of the normal rotation signals are inputted to polyphase filter 1001 as shown in FIG. 5(b). The absolute values of the signals are equal, and the signals have 90° phase differences in the order of Iᵢₙ+, Qᵢₙ+, Iᵢₙ−, and Qᵢₙ−.

In polyphase filter 1001 shown in FIG. 5(b), four resistors of each stage comprise equal values, and four capacitors of each stage comprise equal values. Specifically, resistor R₁ is arranged between Iᵢₙ+ and I₁+, between Qᵢₙ+ and Q₁+, between Iᵢₙ− and I₁−, and between Qᵢₙ− and Q₁−, and capacitor C₁ is arranged between Iᵢₙ+ and Q₁+, between Qᵢₙ+ and I₁−, between Iᵢₙ− and Q₁−, and between Qᵢₙ− and I₁+.

Similarly, resistor R₂ is arranged between I₁+ and I₂+, between Q₁+ and Q₂+, between I₁− and I₂−, and between Q₁− and Q₁−, and capacitor C₂ is arranged between I₁+ and Q₂+, between Q₁+ and I₂−, between I₁− and Q₂−, and between Q₁− and I₂+.

Furthermore, resistor R₃ is arranged between I₂+ and I₃+, between Q₂+ and Q₃+, between I₂− and I₃−, and between Q₂− and Q₃−, and capacitor C₃ is arranged between I₂+ and Q₃+, between Q₂+ and I₃−, between I₂− and Q₃−, and between Q₂− and I₃+.

With such a configuration, for example, a signal inputted from Iᵢₙ+ is outputted to I₁+ through resistor R₁, and a signal inputted from Qᵢₙ− with 270° phase difference from Iᵢₙ+ is outputted to I₁+ through capacitor C₁. At this point, the signal inputted from Iᵢₙ+ is outputted to I₁+ without change in the phase, and the signal inputted from Qᵢₙ− is outputted to I₁+ after the phase is rotated by impedance I/jwC₁ of capacitor C₁. Therefore, in I₁+, the signal passed through resistor R₁ and the signal passed through capacitor C₁ cancel each other.

The foregoing process is similarly carried out for signals inputted from Iᵢₙ+, Qᵢₙ+, Iᵢₙ−, and Qᵢₙ−, and similar processes are further carried out in the circuits of the stages. Therefore, if polyphase filter 1001 shown in FIG. 5(b) is used, the passage of a predetermined frequency signal can be inhibited while maintaining the orthogonality of I signal and Q signal.

In the exemplary embodiment, the resistors and the capacitors of the stages included in polyphase filter 1001 shown in FIG. 5(b) are set to make the values of R₁C₁, R₂C₂, and R₃C₃ different. As a result, the values of the frequencies inhibited by the stages of polyphase filter 1001 are different, and as shown in FIG. 5(c), filter wave characteristics that inhibit the passage of signals in a wide frequency range can be obtained as shown in FIG. 5(c). The inhibition performance by polyphase filter 1001 can be set to 40 dBc or more depending on the orthogonality of I signal and Q signal.

Three peaks downward shown in FIG. 5(c) show frequencies inhibited in the stages of polyphase filter 1001 shown in FIG. 5(b). Furthermore, “−f INHIBITION” shown in FIG. 5(c) denotes characteristics (hereinafter, called “−f inhibition characteristics”) that inhibit the passage of signal within a predetermined negative frequency range (hereinafter, “negative frequency”), “+f INHIBITION” denotes characteristics (hereinafter, called “+f inhibition characteristics”) that inhibit the passage of signal within a predetermined positive frequency range (hereinafter, “positive frequency”), and “ALL-PASS” denotes characteristics (hereinafter, “called all-pass characteristics”) of passing all frequency signals without inhibiting the passage of signal of negative frequencies and positive frequencies.

The −f inhibition characteristics and the +f inhibition characteristics of hopping complex filter 108 will also be called “one side frequency suppression” in the specification.

If hopping complex filter 108 is set to the −f inhibition characteristics, signals of positive frequency pass through, and if hopping complex filter 108 is set to the +f inhibition characteristics, signals of negative frequency pass through. If hopping complex filter 108 is set to all-pass characteristics, signals of negative frequency and positive frequency pass through without inhibition.

For example, C₁=C₂=C₃=1 pF, R₁=216Ω, R₂=320Ω, and R₃=567Ω are set, wideband inhibition characteristics of 264 to 794 MHz (or −264 to −792 MHz) required to remove an image frequency described below can be obtained.

Selector 1002 is used to realize switching of the −f inhibition characteristics and the +f inhibition characteristics of hopping complex filter 108. As shown in FIG. 5(d), selector 1002 comprises, for example, first switch group 1003 and second switch group 1004.

First switch group 1003 passes I signal and Q signal outputted from polyphase filter 1001 during ON. Second switch group 1004 passes I signal outputted from polyphase filter 1001 during ON and switches the normal rotation signal and the inversion signal of Q signal before outputting the Q signal.

With such a configuration, if the switches of first switch group 1003 are turned on and the switches of second switch group 1004 are turned off, hopping complex filter 108 is set to the −f inhibition characteristics. If the switches of first switch group 1003 are turned off and the switches of second switch group 1004 are turned on, hopping complex filter 108 is set to the +f inhibition characteristics.

As described, in second switch group 1004, I signal is directly passed, and the connection of the normal rotational signal and the inversion signal of Q signal is switched. Therefore, the parasitic capacitance of the signal paths of I signal and Q signal, or the charge injection or the gate feed through of the switches may have different values, and the orthogonality of I signal and Q signal may not be maintained due to the phase rotation. Thus, it is preferable to arrange the switches of second switch group 1004 to make the values of the charge injection and the gate feed through equal in order to maintain the orthogonality of the I signal and the Q signal.

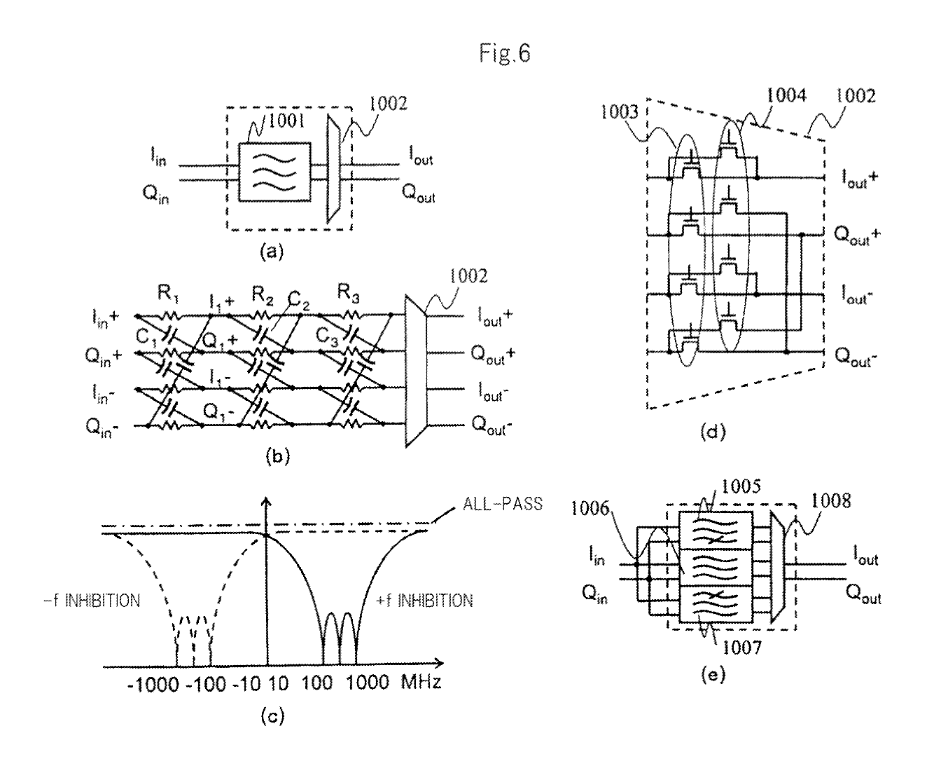

Depending on the configuration of the wireless communication apparatus, a configuration, in which the order of selector 1002 and polyphase filter 1001 is switched as shown in FIGS. 6(a) to 6(e), can also be used. Even with such a configuration, the operation is performed in the same way as the circuit shown in FIGS. 5(b) to 5(e).

Examples of a method of setting hopping complex filter 108 to all-pass characteristics include the following.

For example, there is a configuration in which hopping complex filter 108 comprises third switch group 1009 for connecting input/output terminals (see FIG. 5(d)), and a path for outputting the normal rotation signal and the inversion signal of I signal and Q signal inputted to hopping complex filter 108 is provided. There is also a configuration in which a switch separates the connection of capacitors C₁ to C₃ included in polyphase filter 1001 shown in FIG. 5(b).

In the configuration including third switch group 1009, a signal is outputted through a resistor when the −f inhibition characteristics and the +f inhibition characteristics are selected, and a signal is outputted through a switch when the all-pass characteristics are selected. Therefore, there is a difference in the amount of attenuation of output signal between the −f inhibition characteristics and the all-pass characteristics.

On the other hand, in the configuration in which the switch separates the connection of the capacitors of polyphase filter 1001, a signal is also outputted through the resistor when the all-pass characteristics are selected. Therefore, there is an advantage in which there is no difference in the amount of attenuation of output signal between the −f inhibition characteristics, the +f inhibition characteristics, and the all-pass characteristics. Even in the configuration including third switch group 1009, the problem can be prevented if the input/output terminals of hopping complex filter 108 are connected to an attenuator, such as a resistor, when the all-pass characteristics are selected.

Furthermore, as shown in FIG. 5(e), hopping complex filter 108 may also be configured to include first polyphase filter 1005 having only the −f inhibition characteristics, second polyphase filter 1006 having the all-pass characteristics, third polyphase filter 1007 having only the +f inhibition characteristics, and selector 1008 that switches the filter output of the filters.

As shown in FIG. 5(c), polyphase filter 1001 shown in FIG. 5(b) can obtain the −f inhibition characteristics and the +f inhibition characteristics that are in a relationship of line symmetry across the axis of a reference frequency (0 Hz). The configuration of hopping complex filter 108 shown in FIG. 5(e) is suitable to avoid putting the −f inhibition characteristics and the +f inhibition characteristics in the relationship of line symmetry.

Although hopping complex filter 108 shows an example of configuration for separating the received UWB signal into signals of three bands, the number of separations is not limited to three, but can be any number.

An operation of the receiver of the first exemplary embodiment will be described next.

As described, in the UWB wireless communication apparatus, the UWB signal quickly hops between the bands shown in FIG. 4(b). Rectangles shown in FIG. 4(b) denote OFDM symbols and comprise a frequency band of about 500 MHz, and intervals between the symbols are about 9.5 ns.

The UWB signal, in which the frequency hops, is received by antenna 101 shown in FIG. 3, amplified by low noise amplifier 102, and then inputted to the RF port of first converter 103.

For example, when the first band group is received, a local signal of 3960 MHz generated by first local generator 104 is supplied to first down converter 103. The UWB signals of the first to third bands inputted to the RF port of first down converter 103 are down-converted to IF (Intermediate Frequency) signals from about −792 MHz to +792 MHz and outputted. At this point, I signals and Q signals, which are IF signals of a 90° phase difference, are outputted from first down converter 103.

The I signals and the Q signals can be obtained by supplying local signals to an I-side local port and a Q-side local port included in first down converter 103. The I signals and the Q signals are differential signals and have phase differences of 90° in the order of I+, Q+, I−, and Q−. These four IF signals are inputted to hopping complex filter 108.

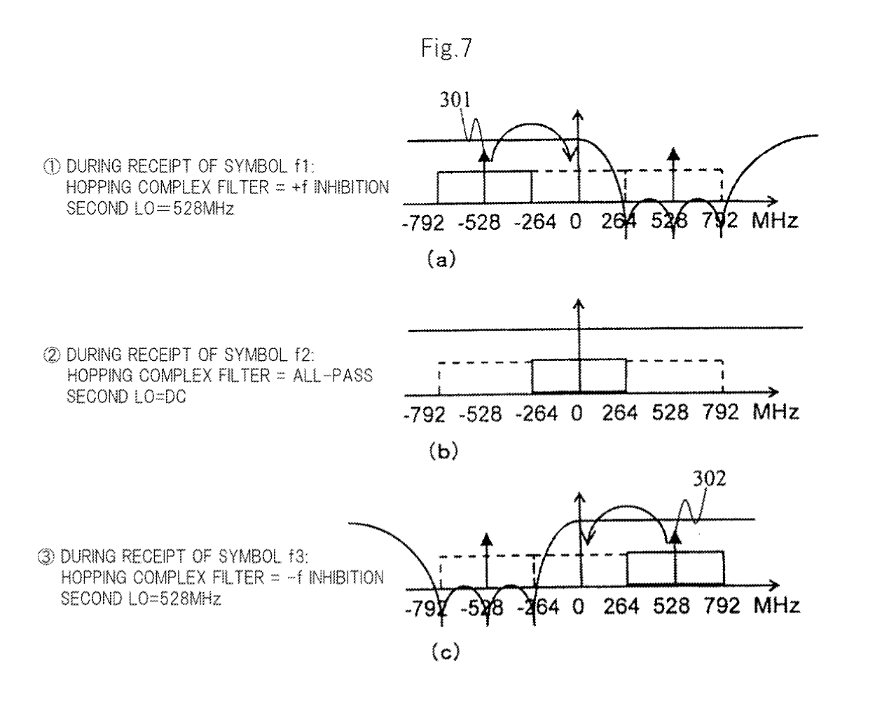

Upon the reception of symbol f1 shown in FIG. 4(b), baseband processing circuit 114 controls hopping complex filter 108 to switch to the +f inhibition characteristics shown in FIG. 5(c). In this case, as shown in FIG. 7(a), hopping complex filter 108 suppresses signal components of a frequency (+264 to +792 MHz) of symbol f3, which is an image frequency of symbol f1 (−792 to −264 MHz). The frequency band of the IF signals passed through hopping complex filter 108 is −792 to +264 MHz and includes symbol f1 and symbol f2.

Second down converter 109 down-converts the IF signal at −792 to +264 MHz outputted from hopping complex filter 108 using local signal (second LO) 301 at 528 MHz generated by second local generator 110. In this case, symbol f1 at −792 to −264 MHz is converted to a baseband signal at −264 to +264 MHz with 0 Hz (DC) being the center frequency, and symbol f2 at −264 to +264 MHz is moved outside the frequency band of the baseband signal.

The output signal of second down converter 109 is inputted to low-pass filter 111 including a cutoff frequency around 230 MHz, and low-pass filter 111 attenuates power of symbol f2 and power of other interference waves and the like.

Variable gain amplifier 112 amplifies the output signal of low-pass filter 111 to a required amplitude in accordance with the dynamic range of A/D converter 113. The output signal of variable amplifier 112 is inputted to A/D converter 113.

A/D converter 113 converts a baseband signal (symbol f1 here) at −264 to +264 MHz to a digital signal at, for example, a conversion rate of 528 Msps. Baseband processing circuit 114 applies a known synchronization detection process or demodulation process of OFDM signal to symbol f1 converted to the digital signal.

Meanwhile, upon the reception of symbol f2 shown in FIG. 4(b), baseband processing circuit 114 controls hopping complex filter 108 to switch to the all-pass characteristics shown in FIG. 5(c). In this case, as shown in FIG. 7(b), hopping complex filter 108 passes signal components at frequency −264 to +264 MHz of symbol f2 outputted from first down converter 103.

Upon the reception of symbol f2, for example, a DC voltage (second LO) for correcting the offset of second down converter 109 is inputted to the LO port of second down converter 109. Therefore, second converter 109 outputs symbol f2 inputted from the RF port from the baseband port. Upon the reception of symbol F2, the output signal of hopping complex filter 108 may be supplied to low-pass filter 111 of the next stage without passing through second down converter 109.

The output signal of second down converter 109 is inputted to low-pass filter 111 including a cutoff frequency around 230 MHz, and low-pass filter 111 attenuates power of unnecessary interference waves and the like.

Subsequently, as in the process for symbol f1, A/D converter 113 converts symbol f2 outputted from low-pass filter 111 to a digital signal, and baseband processing circuit 114 applies a known synchronization detection process or demodulation process of OFDM signal.

Upon receipt of symbol f3 shown in FIG. 4(b), baseband processing circuit 114 controls hopping complex filter 108 to switch to the −f inhibition characteristics shown in FIG. 5(c). In this case, as shown in FIG. 7(c), hopping complex filter 108 suppresses signal components at frequency −792 to −264 MHz of symbol f1, which is an image frequency of symbol f3 (+264 to +792 MHz). Therefore, the frequency band of the IF signal that passed through hopping complex filter 108 is −264 to +792 MHz and includes symbol f2 and symbol f3.

Second down converter 109 down-converts the IF signal at −264 to +792 MHz outputted from hopping complex filter 108 using local signal 302 at 528 MHz generated by second local generator 110. At this point, symbol f3 at +264 to +792 MHz is converted to a baseband signal at −264 to +264 with 0 Hz (DC) being the center frequency, and symbol f2 at −264 to +264 MHz is moved outside the frequency band of the baseband signal.

The output signal of second down converter 109 is inputted to low-pass filter 111 having a cutoff frequency around 230 MHz, and low-pass filter 111 attenuates power of symbol f2 and power of other interference waves and the like.

Subsequently, as in the processes for symbols f1 and f2, A/D converter 113 converts symbol f3 outputted from low-pass filter 111 to a digital signal, and baseband processing circuit 114 applies a known synchronization detection process or demodulation process of OFDM signal to the signal.

According to the wireless communication apparatus of the first exemplary embodiment, the frequencies of the local signals are set to the center frequencies of the band groups. As a result, the frequency of the IF signal outputted from the first down converter can be reduced as compared to the configuration of setting the frequencies of the local signals to the center frequencies of the bands as in Patent Document 1. Furthermore, although the circuit of the latter stage of the first down converter needs to operate at 1320 MHz in Patent Document 2, only 792 MHz, which is about 1/1.7 of the frequency, is necessary in the exemplary embodiment. Furthermore, one frequency of a local signal is set for each band group, and the mixers or dividers do not have to be used to generate the local signal. Therefore, the circuit area and power consumption of local generator 104 can be reduced, and the DC offset and the local leak can be reduced.

Flopping complex filter 108 is provided, and the image frequency is removed when carrying out fast hopping, and signal power of negative frequency or positive frequency can be quickly cut out. Therefore, only a narrow operating frequency is necessary for the circuit of the latter stage of the first down converter as compared to the configuration in which the frequency of the local signal is set to symbol f1 described in Patent Document 2. Providing hopping complex filter 108 can also reduce the influence of an interference wave and the like existing outside the baseband. Furthermore, only 528 MHz is necessary for the frequency of the second local signal, and second down converter 109 can be easily formed.

Furthermore, in the exemplary embodiment, the conversion rate of the A/D converter can be significantly reduced as compared to related art. In the exemplary embodiment, the frequencies of the local signals are set to the center frequencies of the band groups, and the negative frequency band and the positive frequency band of the IF signals are equal. Therefore, the conversion rate necessary in the A/D converter can be minimized even if there is only one local signal. As a result, the circuit area and power consumption of A/D converter 113 can be reduced.

Specifically, it is only necessary to apply A/D conversion to the symbol of one band at about a 528 MHz (−264 to +264 MHz) frequency band in the exemplary embodiment. Therefore, the conversion rate of the A/D converter is about 528 Msps required to convert one symbol, and only a minimum rate is necessary.

On the contrary, the frequency of the local signal is set in accordance with the frequency of symbol f1 in Patent Document 2. Therefore, four symbols need to be collectively converted, and the conversion rate of A/D converter 113 is 2112 Msps. The conversion rate of A/D converter 113 may also be set to a value required in A/D conversion of two or more symbols in the exemplary embodiment.

The tone interval of symbol used in the UWB wireless communication apparatus is 4.125 MHz, and the number of tones is 128. Therefore, the conversion rate necessary to apply A/D conversion to one symbol can be 528 Msps. However, the conversion rate can be set to a non-integral multiple, such as about 1.1 times or 1.2 times, if necessary. This is also applied to the D/A converter included in the transmitter shown in a fourth exemplary embodiment described later.

In the exemplary embodiment, hopping complex filter 108 is used to suppress the image frequency. Therefore, even if a radio wave used in another wireless communication apparatus is mixed with, for example, the frequency band of symbol f3, symbol f1 is not significantly influenced. Furthermore, symbol f1 is scarcely influenced even if there is thermal noise or the like in the frequency band of symbol f3.

Since hopping complex filter 108 shown in the exemplary embodiment comprises only capacitors, resistors, and switches, a stationary current is basically unnecessary, and hopping complex filter 108 has high linearity. The meaning of high linearity is important for the UWB wireless communication apparatus including a multiplicity of interference sources, such as wireless LAN and cell phones. A configuration, in which noise is not generated by use of an active element, is also a great advantage particularly for the receiver. For example, in an active filter formed by using a transconductance amplifier, a high degree of configuration is necessary to obtain the filter wave characteristics similar to those of hopping complex filter 108. Therefore, there are problems in which the stationary current becomes large, obtaining high linearity is difficult, thermal noise or 1/f noise is large, etc.

As described, the filter wave characteristics of hopping complex filter 108 are switched by a control signal outputted from baseband processing circuit 114. Baseband processing circuit 114 can use information stored in the preamble of the received UWB signal to establish synchronization and determine the switch timing of the filter wave characteristics. The hopping sequence can be identified from header information included in the preamble.

### Second Exemplary Embodiment

A second exemplary embodiment will be described next with reference to the drawings.

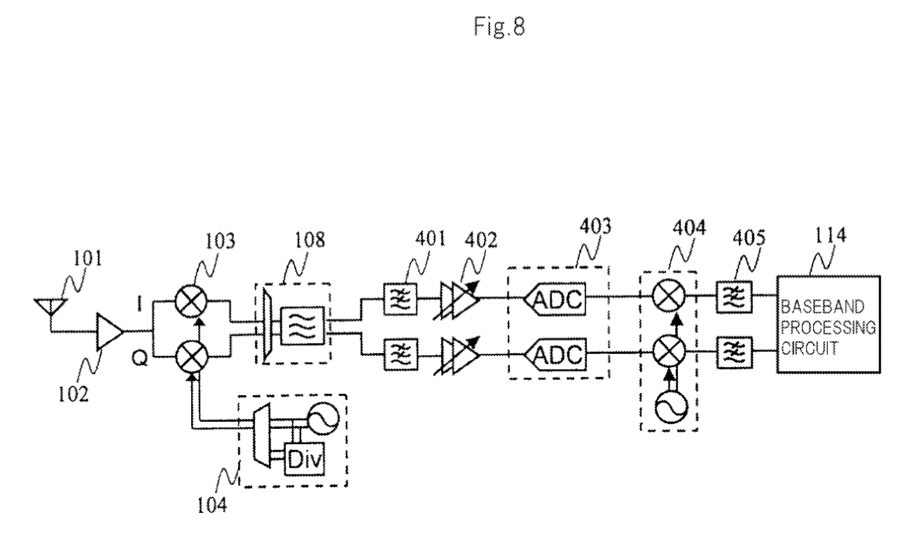

FIG. 8 is a block diagram showing a configuration of a UWB wireless communication apparatus of the second exemplary embodiment. As in the first exemplary embodiment, the second exemplary embodiment illustrates an example of a receiver that receives a UWB signal.

As shown in FIG. 8, the receiver of the second exemplary embodiment comprises reception antenna 101, low noise amplifier (LNA) 102, first down converter 103, first local generator 104, hopping complex filter 108, baseband processing circuit 114, first low-pass filter 401, variable gain amplifier 402, A/D converter 403, second down converter 404, and second low-pass filter 405.

The receiver of the second exemplary embodiment is an example of realizing second down converter 404 and second low-pass filter 405 by digital signal processing. The configurations of reception antenna 101, low noise amplifier (LNA) 102, first down converter 103, first local generator 104, hopping complex filter 108, and baseband processing circuit 114 are the same as in the receiver shown in the first exemplary embodiment, and the description will not be repeated.

First low-pass filter 401 has a cutoff frequency around 792 MHz, passes frequency components of symbol f1 to symbol f3 outputted from hopping complex filter 108, and attenuates other frequency components. First low-pass filter 401 is included to attenuate unnecessary radio waves (so-called blockers), noise, and the like existing outside the frequency band used in the UWB wireless communication apparatus.

Variable gain amplifier 402 amplifies an output signal of first low-pass filter 401 in accordance with the dynamic range of A/D converter 403, as in the first exemplary embodiment. Variable gain amplifier 402 of the exemplary embodiment needs to amplify signals of up to about 792 MHz.

A/D converter 403 of the exemplary embodiment comprises a conversion rate for converting an IF signal at −528 to +528 MHz into a digital signal. When A/D conversion is performed at such a conversion rate, for example, signal components at −792 to −528 MHz of symbol f1 outside the Nyquist frequency emerge at +264 to +528 MHz in the frequency band of symbol f3. This is caused by generation of an alias around 528 MHz, which is the Nyquist frequency, by AD conversion.

In the IF signal inputted to A/D converter 403, signal components of the frequency of symbol f3 are already removed by hopping complex filter 809 upon, for example, receipt of symbol f1. Therefore, there is no problem even if signal components of symbol f1 emerge in the frequency band of symbol f3 by A/D conversion.

Second down converter 404 of the exemplary embodiment comprises similar functions as second down converter 109 shown in the first exemplary embodiment and is realized by digital signal processing as described. Similarly, second low-pass filter 405 has similar functions as low-pass filter 111 shown in the first exemplary embodiment and is realized by digital signal processing as described. For example, a reconstruction device that can change the circuits formed inside by a program, a CPU that executes processing according to a program, or a DSP that executes arithmetic processing can be used to realize the functions of second down converter 404 and second low-pass filter 405.

An operation of the receiver of the second exemplary embodiment shown in FIG. 8 will be described next with reference to the drawings.

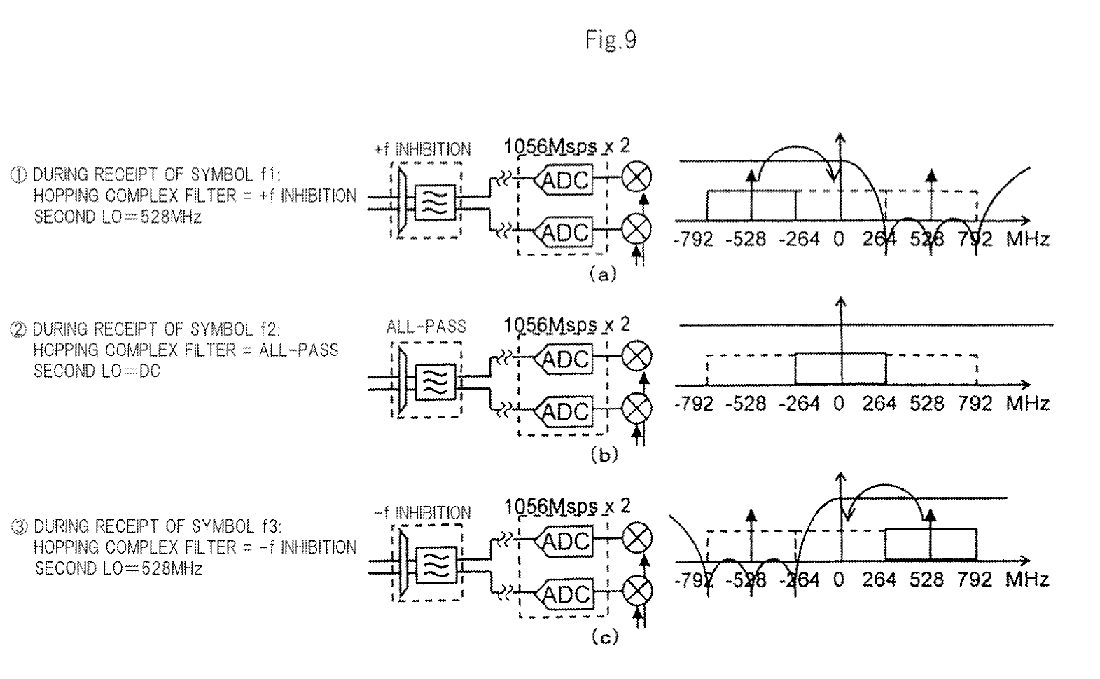

Upon receipt of symbol f1 (FIG. 9(a)), baseband processing circuit 114 controls hopping complex filter 108 to switch to the +f inhibition characteristics shown in FIG. 5(c) as in the first exemplary embodiment. In this case, hopping complex filter 108 suppresses the signal components at frequency +264 to +792 MHz of symbol f3, which is an image frequency of symbol f1 (−792 to −264 MHz). Therefore the frequency band of the IF signal that passed through hopping complex filter 108 is −792 to +264 MHz and includes symbol f1 and symbol f2.

The IF signal that passed through hopping complex filter 108 is inputted to first low-pass filter 401. First low-pass filter 401 passes the signal components of symbol f1 and symbol f2 and suppresses unnecessary radio waves and noise outside the cutoff frequency.

The IF signal that passed through first low-pass filter 401 is amplified by variable gain amplifier 402 and inputted to A/D converter 403.

A/D converter 403 converts symbol f1 included in the IF signal to a digital signal including signal components of −528 to −264 MHz and +264 to +528 MHz and converts symbol f2 to a digital signal including signal components of −264 to +264 MHz. The IF signal converted to the digital signal by A/D converter 403 is inputted to second down converter 404.

Similar to second down converter 109 shown in the first exemplary embodiment, second down converter 404 down-converts the IF signal converted to the digital signal. At this point, symbol f1 including signal components of −528 to −264 MHz and +264 to +528 MHz are converted to a baseband signal of −264 to +264 MHz with 0 Hz (DC) being the center frequency, and symbol f2 at −264 to +264 MHz is moved outside the frequency band of the baseband signal.

The output signal of second down converter 404 is inputted to second low-pass filter 405 including a cutoff frequency around 230 MHz, and second low-pass filter 405 attenuates power of symbol f2 and power of other interference waves and the like.

Symbol f1 that passed through second low-pass filter 405 is inputted to baseband processing circuit 114, and a known synchronization detection process or OFDM demodulation process is applied.

Meanwhile, upon receipt of symbol f2 (FIG. 9(b)), baseband processing circuit 114 controls hopping complex filter 108 to switch to the all-pass characteristics shown in FIG. 5(c). In this case, hopping complex filter 108 passes the signal components at frequency −264 to +264 MHz of symbol f2 outputted from first down converter 103.

The IF signal that passed through first low-pass filter 401 is amplified by second variable gain amplifier 402 and inputted to A/D converter 403.

A/D converter 403 converts symbol f2 at −264 to +264 MHz included in the IF signal to a digital signal. The IF signal converted to the digital signal by A/D converter 403 is inputted to second down converter 404.

Similar to second down converter 109 shown in the first exemplary embodiment, second down converter 404 uses a DC voltage as a local signal (second LO) and outputs symbol f2, which is converted to the digital signal, without down conversion.

The output signal of second down converter 404 is inputted to second low-pass filter 405 including a cutoff frequency around 230 MHz, and second low-pass filter 405 attenuates power of unnecessary interference waves and the like.

Symbol f2 that passed through second low-pass filter 405 is inputted to baseband processing circuit 114, and a known synchronization detection process or OFDM demodulation process is applied.

Upon the reception of symbol f3 (FIG. 9(c)), baseband processing circuit 114 controls hopping complex filter 108 to switch to the −f inhibition characteristics shown in FIG. 5(c) as in the first exemplary embodiment. In this case, hopping complex filter 108 suppresses signal components at frequency −792 to −264 MHz of symbol f1, which is an image frequency of symbol f3 (+264 to +792 MHz). Therefore, the frequency band of the IF signal that passed through hopping complex filter 108 is +264 to +792 MHz and includes symbol f2 and symbol f3.

The IF signal that passed through hopping complex filter 108 is inputted to first low-pass filter 401. First low-pass filter 401 passes the signal components of symbol f2 and symbol f3 and suppresses unnecessary radio waves and noise outside the cutoff frequency.

The IF signal that passed through first low-pass filter 401 is amplified by variable gain amplifier 402 and inputted to A/D converter 403.

A/D converter 403 converts symbol f3 included in the IF signal to a digital signal including signal components at −528 to −264 MHz and +264 to +528 MHz and converts symbol f2 to a digital signal including signal components at −264 to +264 MHz. The IF signal converted to the digital signal by A/D converter 403 is inputted to second down converter 404.

Similar to second down converter 109 shown in the first exemplary embodiment, second down converter 404 down-converts the IF signal converted to the digital signal. At this point, symbol f3 including signal components at −528 to −264 MHz and +264 to +528 MHz is converted to a baseband signal at −264 to +264 MHz with 0 Hz (DC) being the center frequency, and symbol f2 at −264 to +264 MHz is moved outside the frequency band of the baseband signal.

The output signal of second down converter 404 is inputted to second low-pass filter 405 including a cutoff frequency around 230 MHz, and second low-pass filter 405 attenuates power of symbol f2 and power of other interference waves and the like.

Symbol f3 that passed through second low-pass filter 405 is inputted to baseband processing circuit 114, and a known synchronization detection process or OFDM demodulation process is applied.

According to the receiver of the second exemplary embodiment, in addition to the advantages obtained by fixing the local frequencies at the band groups and by using the hopping complex filter shown in the first exemplary embodiment, the down conversion using the analog circuit is performed just once, and a mixer, a local signal generator, and the like necessary for the second conversion are not necessary. Therefore, the circuit area and power consumption can be reduced.

The conversion rate of A/D converter 403 is about 1 Gsps, and power consumption can be reduced to half compared to the configuration that requires a conversion rate of about 2 Gsps as in Patent Document 2.

Furthermore, up to only about 792 MHz is necessary for the frequency of the signal passing through variable gain amplifier 402, and the frequency is lower than 1.3 GHz in the example of related art. As the operating frequency of variable gain amplifier 402b is reduced, the gain per amplifier stage can be increased based on a principle in which a known product of gain and band is constant. Therefore, the number of stages of amplifier can be reduced, and the circuit area and power consumption of variable gain amplifier 402 can be reduced.

In the receiver of the exemplary embodiment, a configuration in which an interleaving operation is carried out can be used for A/D converter 403. In that case, A/D converter 403 comprises two A/D converters for I signal and Q signal. An interleaving operation of carrying out a process of applying A/D conversion to I signal and Q signal and a process of applying A/D conversion to only one of I signal and Q signal can realize a conversion rate twice as fast as the conversion time of one A/D converter.

For example, if the conversion rate of the A/D converter is 1056 Msps, I signal and Q signal are usually converted at 1056 Msps, and during interleaving, either an I signal or a Q signal is converted at 2112 Msps, which is a speed twice as fast as 1056 Msps.

As for such a configuration, a configuration of arranging, immediately before the A/D converters, a selector that directly passes I signal and Q signal or that inputs only I signal or Q signal to two A/D converters can be considered to switch the existence or nonexistence of interleaving.

In that case, a selector that directly passes I signal and Q signal after conversion or that sorts the signals alternately outputted from the A/D converters in an appropriate order during interleaving can also be arranged on the output side of the A/D converters.

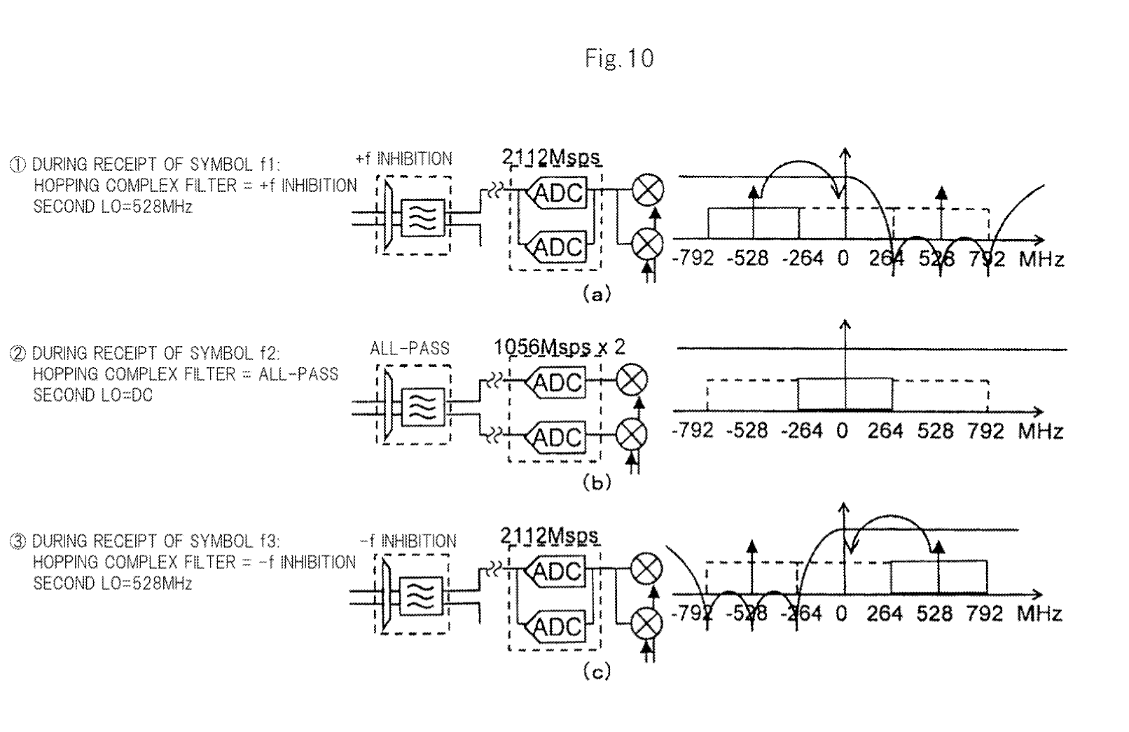

An operation of the A/D converter when carrying out interleaving is shown in FIG. 10.

Hereinafter, it is assumed that A/D converter 403 performs an interleaving operation upon receipt of symbols f1 and f3 and that the interleaving operation is not performed upon the reception of symbol f2.

Upon receipt of symbol f1, either an I signal or a Q signal of symbol f1 is outputted from A/D converter 403 and inputted to second down converter 404.

Similar to the second down converter of the first exemplary embodiment, second down converter 404 down-converts inputted symbol f1 at −792 to −264 MHz to a baseband signal at −264 to +264 MHz (FIG. 10(a)). At this point, symbol f2 at −264 to +264 MHz is moved outside the frequency band of the baseband signal.

Upon receipt of symbol f2, symbol f2 passes through hopping complex filter 108 and is inputted to A/D converter 403 (FIG. 10(b)).

In that case, A/D converter 403 does not perform the interleaving operation, and the A/D converters apply A/D conversion to the I signal and Q signal, respectively. Since interleaving is not performed here, the conversion rate of the I signal and Q signal is 1056 Msps. The signal of symbol f2 exists between −264 and +264 MHz, and the Nyquist frequency as a result of the A/D conversion is 528 MHz, which is ½ of 1056 MHz. Therefore, A/D conversion is possible with a sufficient margin.

As described, although the frequency components at −528 to −792 MHz of symbol f1 return back to −264 to −528 MHz in the exemplary embodiment, there is no problem because the components do not overlap with the frequency of symbol f2. Similarly, the frequency components at +528 to +792 MHz of symbol f3 do not pose a problem, either.

Upon receipt of symbol f3, as in the first exemplary embodiment, hopping complex filter 108 switches to the −f inhibition characteristics and passes symbol f3 while suppressing the frequency of symbol f1 (FIG. 10(c)).

In the same way as for symbol f1, A/D converter 403 performs the interleaving operation and applies A/D conversion either an I signal or a Q signal. The signal after A/D conversion is inputted to second down converter 404, converted to a baseband signal, and outputted.

The conversion rate is about 1 Gsps even when A/D converter 403 performs the interleaving operation, and power consumption can be approximately halved compared to the case of using a conversion rate of about 2 Gsps as in related art.

According to the exemplary embodiment, only about 1 Gsps conversion rate is necessary to apply A/D conversion to two symbols in a band of about 528 MHz. Therefore, the conversion rate that is necessary to convert four symbols as in Patent Document 2 is not necessary.

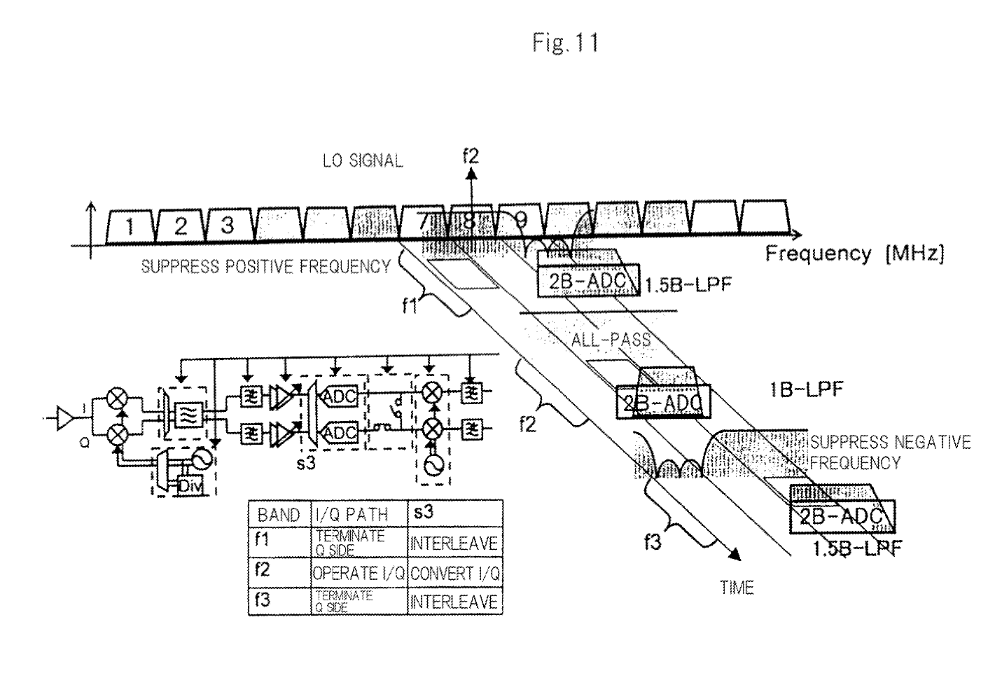

FIG. 11 schematically shows an operation of the exemplary embodiment described above.

### Third Exemplary Embodiment

A third exemplary embodiment will be described next with reference to the drawings.

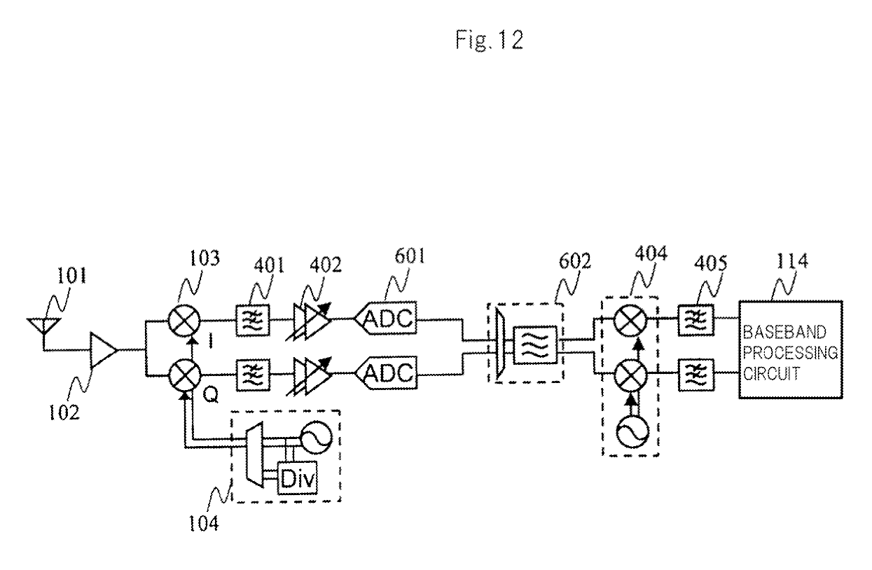

FIG. 12 is a block diagram showing a configuration of a UWB wireless communication apparatus of the third exemplary embodiment. As in the first and second exemplary embodiments, the third exemplary embodiment illustrates an example of a receiver that receives a UWB signal.

As shown in FIG. 12, reception antenna 101, low noise amplifier (LNA) 102, first down converter 103, first local generator 104, first low-pass filter 401, variable gain amplifier 402, second down converter 404, second low-pass filter 405, baseband processing circuit 114, A/D converter 601, and hopping complex filter 602 are included.

The receiver of the third exemplary embodiment is different from the first exemplary embodiment in that hopping complex filter 602, second down converter 404, and second low-pass filter 405 are realized by digital signal processing. For example, a reconstruction device that can change the circuits formed inside by a program, a CPU that executes processing according to a program, or a DSP that executes arithmetic processing can be used to realize the functions of hopping complex filter 602, second down converter 404, and second low-pass filter 405. The configurations and the operations of reception antenna 101, low noise amplifier (LNA) 102, first down converter 103, first local generator 104, and baseband processing circuit 114 are the same as in the receiver shown in the first exemplary embodiment, and the configurations and the operations of first low-pass filter 401, variable gain amplifier 402, second down converter 404, and second low-pass filter 405 are the same as the second exemplary embodiment. Therefore, the description will not be repeated.

As shown in FIG. 12, the receiver of the exemplary embodiment does not comprise a hopping complex filter in the latter stage of first down converter 103. First low-pass filter 401 and variable gain amplifier 402 operate in the same way as the second exemplary embodiment. A/D converter 601 converts the output signal of first low-pass filter 401 to a digital signal.

A/D converter 601 of the exemplary embodiment comprises a conversion rate of 1584 Msps and collectively converts symbol f1 to symbol f3 to a digital signal. The output signal of A/D converter 601 is inputted to hopping complex filter 602, and the output signal of hopping complex filter 602 is inputted to second down converter 404. The operation after second down converter 404 is the same as in the second exemplary embodiment.

In the exemplary embodiment, hopping complex filter 602 is realized by digital signal processing. Therefore, in addition to the advantages shown in the first and second exemplary embodiments, the analog circuit can be made further smaller than that in the second exemplary embodiment. Such a configuration allows making the circuit area smaller than that in the second exemplary embodiment, and crosstalk and the like that emerge in a formation by analog circuit can also be reduced.

As described, A/D converter 601 of the exemplary embodiment comprises a conversion rate of 1584 Msps. In the exemplary embodiment, since A/D conversion is collectively applied to three symbols of about 528 MHz band, only about 1584 Msps is necessary for the conversion rate of A/D converter 601. Although the conversion rate of A/D converter 601 in the exemplary embodiment is higher than that in the second exemplary embodiment, only about ¾ of conversion rate is necessary compared to the example of related art. Therefore, power consumption is also about ¾.

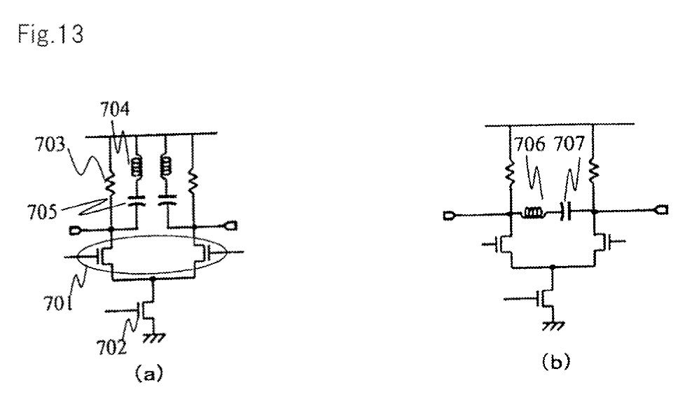

It is preferable that first down converter 103 of the exemplary embodiment has ability to remove a blocker. An example of configuration of a down converter that is suitable as first down converter 103 and that has removal ability of blocker is shown in FIG. 13.

First down converter 103 shown in FIG. 13(a) comprises differential transistor pair 701 and tail transistor 702.

Differential transistor pair 701 and tail transistor 702 form a single-balance mixer. Inductor 704 and capacitor 705 connected in series are connected to load resistance 703 in parallel.

In the configuration shown in FIG. 13(a), inductor 704 and capacitor 705 are low-resistant near the resonance frequency, and the load impedance is reduced to reduce the conversion gain for the mixer. Therefore, setting the resonance frequency to the frequency of the blocker allows the mixer to have ability to remove the blocker.

For example, when the first band group is received, the frequency of the local signal inputted to first down converter 103 is set to 3960 MHz, which is the center frequency. In this case, a radio wave of 5.2 GHz used in a wireless LAN compliant with 802.11a is a blocker. This is a frequency about 1.2 GHz apart from 3960 MHz.

Meanwhile, first down converter 103 operates at an IF frequency band of about −0.8 to 0.8 GHz. More specifically, it is preferable that a signal up to 0.8 GHz is passed without attenuation at the IF output of the first down converter and that a blocker around 1.2 GHz is attenuated. Therefore, setting the resonance frequency by inductor 704 and capacitor 705 shown in FIGS. 13(a) to 1.2 GHz can significantly attenuate the blocker.

First down converter 103 shown in FIG. 13(b) is an example of a configuration in which inductor 706 and capacitor 707 connected in series are connected between differential outputs. Such a configuration can also obtain the same advantage as the configuration shown in FIG. 13(a). Although a common mode signal cannot be removed, the configuration shown in FIG. 13(b) is advantageous in that the circuit area can be reduced because the number of elements can be reduced.

Since the transmission power is usually large in wireless LAN, it is preferable that the amount of attenuation of the blocker around 1.2 GHz is 40 dB or more. However, since the difference in frequency is small between 0.8 GHz and 1.2 GHz, the degree of configuration of the low-pass filter needs to be large to remove the blocker of wireless LAN and the like while passing a signal of a frequency band used in the UWB wireless communication apparatus. Therefore, the circuit area and power consumption of the low-pass filter increase.

As in the exemplary embodiment, if the circuits shown in FIG. 13(a) or 13(b) are used in first down converter 103, the circuit area and power consumption of the low-pass filter can be reduced.

### Fourth Exemplary Embodiment

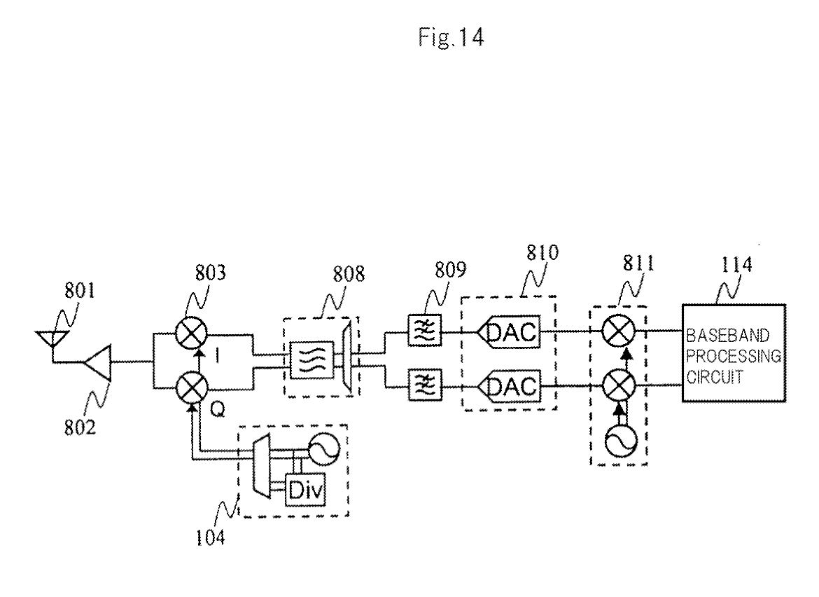

FIG. 14 is a block diagram showing a configuration of a UWB wireless communication apparatus of the fourth exemplary embodiment. The fourth exemplary embodiment shows an example of a transmitter that transmits a UWB signal.

As shown in FIG. 14, the transmitter of the exemplary embodiment comprises baseband processing circuit 114, first up converter 811, D/A converter 810, low-pass filter 809, hopping complex filter 808, first local generator 104, second up converter 803, power amplifier 802, and transmission antenna 801.

First up converter 811 is realized by digital signal processing, and for example, uses a local signal at 528 MHz to convert a baseband signal at −264 to +264 MHz to an IF signal at +264 to +792 MHz with 528 MHz as the center frequency. Similar to the receiver, first up converter 811 can just pass the signals inputted from baseband processing circuit 114 because there is no need to convert the frequency upon the transmission of symbol f2.

D/A converter 810 of the exemplary embodiment can apply D/A conversion from the center frequency of symbol f1 to the center frequency of symbol f3. Specifically, a conversion rate capable of applying D/A conversion to the IF signal at −528 to +528 MHz can be included.

When the D/A conversion is performed with such a conversion rate, for example, signal components at −792 to −528 MHz of symbol f1 that are outside the Nyquist frequency emerge at +264 to +528 MHz in the frequency band of symbol f3. This is because the D/A conversion generates an alias around 528 MHz, which is the Nyquist frequency.

In the transmitter of the exemplary embodiment, hopping complex filter 808 removes the signal components of the frequency of symbol f3 during, for example, the transmission of symbol f1. Therefore, there is no problem even if the signal components of symbol f1 emerge in the frequency band of symbol f3 due to the D/A conversion.

Low-pass filter 809 passes the frequency components in the IF band at −792 to +792 MHz and attenuates the frequency components outside the IF band. Upon the transmission of symbol f1 or symbol f3, the frequency of symbol f2 is no signal (null), and the alias generated at frequency below symbol f1 and above symbol f3 is also null.

Since the band of symbol f2 is about 528 MHz, the null of the alias has a bandwidth of about 528 MHz. More specifically, upon transmission of symbol f1 and symbol f2, signals exist in a frequency band up to about 792 MHz in terms of absolute value. A frequency band of +792 to +1320 MHz is a null section, and steep attenuation characteristics are not required in low-pass filter 809. Therefore, the degree of configuration of low-pass filter 809 can be reduced.

Meanwhile, upon transmission of symbol f2, an alias is generated at a frequency above 792 MHz, and a signal at +264 to +792 MHz is null. Therefore, upon transmission of symbol f2, it is preferable to set the cutoff frequency of low-pass filter 809 lower than during the transmission of symbol f1 and symbol f3. As a result, low-pass filter 809 in a relatively lower degree configuration than in the transmission of symbol f2 can be used. However, when power consumption, the circuit area, and the like of the entire transmitter are not affected even if a high-degree filter is used, a low-pass filter with cutoff frequency fixed at 792 MHz may be used.

Hopping complex filter 809 has the same functions as hopping complex filter 108 used in the receiver. However, the filter wave characteristics of the hopping complex filter can be changed between the receiver and the transmitter as necessary.

An operation of the transmitter of the fourth exemplary embodiment will be described next.

An OFDM baseband signal for transmission is outputted from baseband processing circuit 114 shown in FIG. 14 and inputted to first up converter 811.

Upon transmission of symbol f1, first up converter 811 converts a baseband signal around DC to, for example, an IF signal around 528 MHz. The IF signal outputted from first up converter 811 is inputted to D/A converter 810.

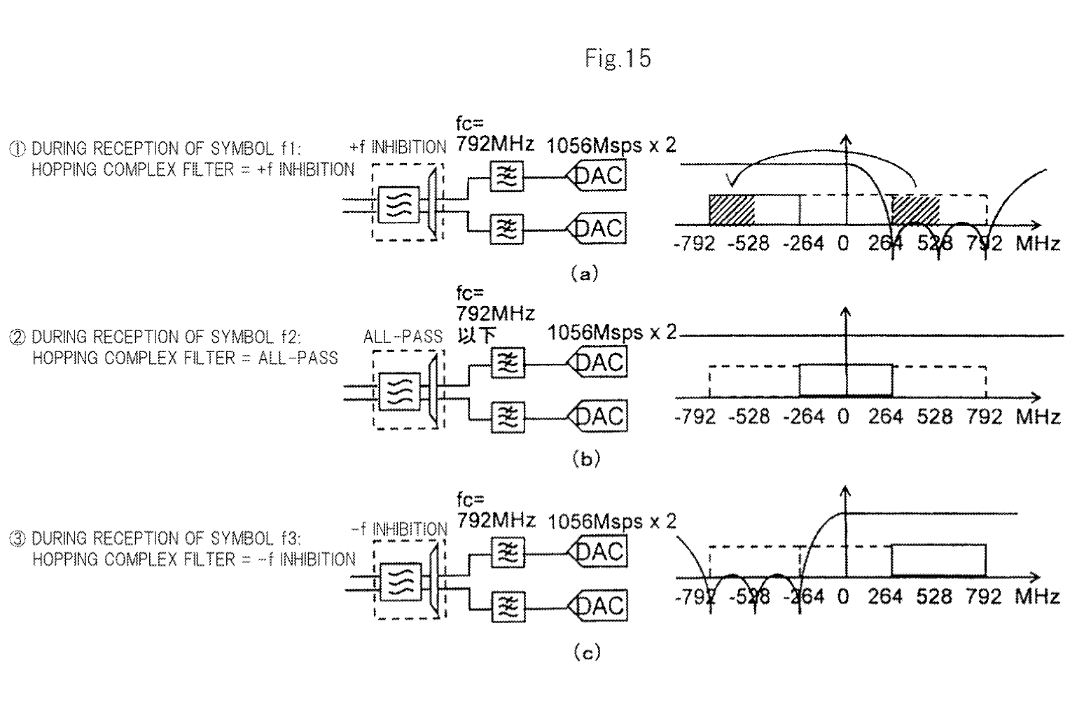

As described, the sampling frequency and the conversion rate of D/A converter 810 of the exemplary embodiment is 1056 MHz, and the Nyquist frequency is 528 MHz. Therefore, as shown by oblique lines of FIG. 15(a), a signal at +264 to +528 MHz emerges as an alias in the frequency band −792 to −528 MHz of symbol f1.

Low-pass filter 809 has a cutoff frequency at, for example, 792 MHz or more to remove unnecessary signals. An example of unnecessary signals includes an unnecessary alias at 1320 MHz or less. The output signal of low-pass filter 809 is inputted to hopping complex filter 808.

Hopping complex filter 808 switches to the +f inhibition characteristics upon the transmission of symbol f1, suppresses the frequency components of symbol f3, and passes symbol f1. The output signal of hopping complex filter 808 is inputted to the IF port of second up converter 803.

Second up converter 803 uses the local signal generated by first local generator 104 to convert the IF signal to the RF signal. The output signal of second up converter 803 is inputted to power amplifier 802. Power amplifier 802 amplifies the signal to a predetermined transmission level, and the signal is radiated through transmission antenna 801.

Upon the transmission of symbol f2, first up converter 811 outputs symbol f2 without up conversion. Examples of the method of terminating the up conversion of first up converter 811 includes a method of inputting a DC signal as a local signal to first up converter 811 and a method of using a switch and the like to set a path that does not pass through first up converter 811.

D/A converter 810 converts symbol f2 that passed through first up converter 811 to an analog signal, and low-pass filter 809 removes the unnecessary alias.

As shown in FIG. 15(b), there is no signal in symbol f1 and symbol f3 at this point. Therefore, a transition zone can be provided to the area as described above, and only a relatively low-degree configuration is necessary for the low-pass filter. Preferably, when symbol f2 is selected, the cutoff frequency of low-pass filter 809 is switched to be lower than in the transmission of symbol f1 and symbol f3. Hopping complex filter 808 switches to the all-pass characteristics and passes symbol f2.

Upon the transmission of symbol f3, hopping complex filter 808 switches to −f inhibition characteristics, suppresses the frequency components of symbol f1, and passes symbol f3 (see FIG. 15(c)).

The frequencies of the local signals generated by first local generator 104 are set to the center frequencies of the band groups as in the receivers shown in the first to third exemplary embodiments, and the frequencies are fixed in the band groups even if the frequencies are hopped. More specifically, there is only one frequency of a local signal in each band group.

Therefore, in the transmitter of the exemplary embodiment, the local leak generated by unevenness between the elements forming second up converter 803 can be reduced. For example, if there are three local signals, the local leak needs to be corrected in each of three frequencies. Therefore, the scale of the correction circuit, such as a D/A converter, used in the correction becomes large.

On the other hand, in the transmitter of the exemplary embodiment, there is only one frequency in which the local leak needs to be corrected, and there is no need to switch the amount of correction in accordance with hopping. Therefore, the scale of circuit and power consumption for the correction can be significantly reduced. Furthermore, in the exemplary embodiment, since D/A conversion is applied to two symbols in an about 528 MHz frequency band, only about 1 Gsps conversion rate is necessary for the D/A converter.

According to the transmitter of the exemplary embodiment, the frequency of the local signal generated by the local generator is set to the center frequency of the band group to equalize the frequency band on the negative side and the frequency band on the positive side of the IF signal. Therefore, even if there is only one local signal, the conversion rate required for the D/A converter can be minimized. Furthermore, since there is one frequency of a local signal in each band group, there is no need to generate a local signal using a mixer or a divider.

Furthermore, as the hopping complex filter, in which the filter wave characteristics can be switched, is included, the image signal that changes in every band hopping can be removed, and the signal of a desired band can be cut out. Therefore, a large-scale circuit or a circuit that quickly operates does not have to be used in a local generator, a D/A converter, and the like. As a result, the circuit area and power consumption of the local generator, the D/A converter, and the like can be reduced, and the local leak and the spurious signal generated due to fast hopping can be reduced.

In the description related to FIGS. 14 and 15, it is assumed that hopping complex filter 808 shown in FIG. 5 is used. However, the configuration shown in FIG. 6 may be used for hopping complex filter 808 as necessary in accordance with a target operation.

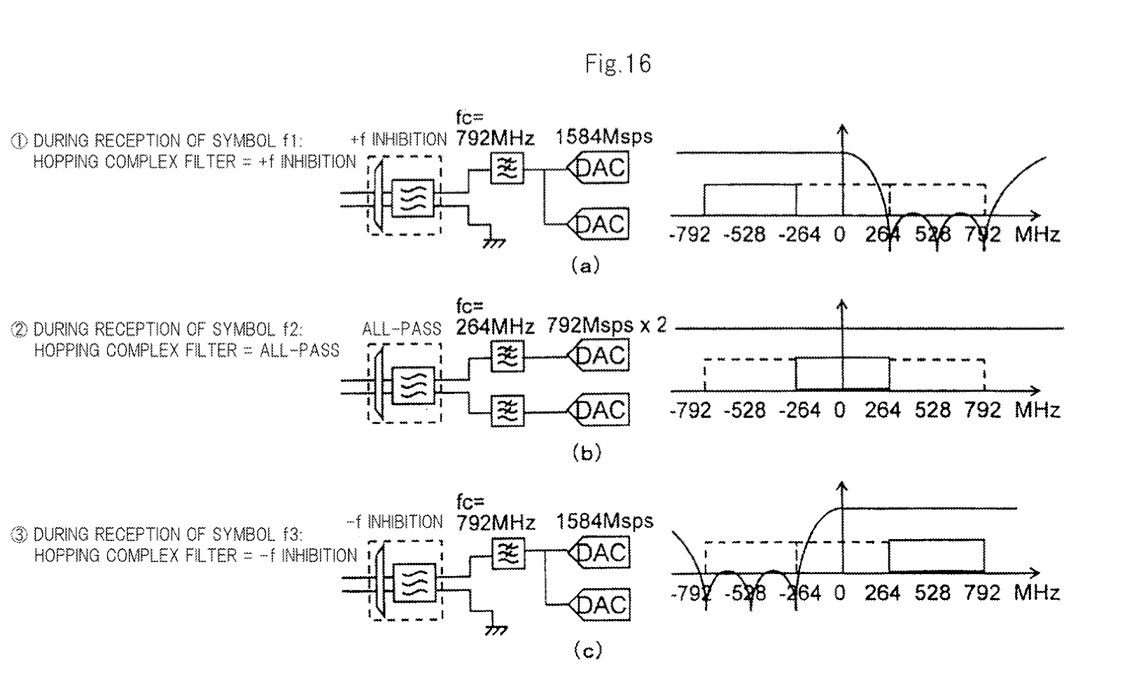

In the transmitter of the exemplary embodiment, a configuration of carrying out interleaving may be used for D/A converter 810. The operation will be described with reference to FIG. 16.

FIG. 16 is an example of configuration for switching the presence of an interleaving operation by two D/A converters.

Two D/A converters shown in FIG. 16 can comprise about ½ of the conversion rate necessary to apply D/A conversion from symbol f1 to symbol f3 or a greater conversion rate. Specifically, since symbol f1 to symbol f3 is about −792 to +792 MHz, 1584 Msps that covers the range is usually necessary for the conversion rate. However, the conversion rate can be about 792 MHz or more in the exemplary embodiment.

This is because hopping complex filter 808 having the +f inhibition characteristics or the −f inhibition characteristics removes unnecessary bands. For example, D/A converter 810 performs the interleaving operation upon transmission of symbol f1. In this case, two A/D converters having a 792 Msps conversion rate perform the interleaving operation, and 1584 Msps, or twice as much conversion rate, can be obtained for D/A converter 810. As a result, the D/A conversion is applied either an I signal or a Q signal, for example, the I signal. However, hopping complex filter 808 removes the image signal (symbol f3 in the case of symbol f1) generated by applying D/A conversion to one of the signals. Therefore, only symbol f1 is cut out by providing hopping complex filter 808.

Meanwhile, upon the transmission of symbol f2, two D/A converters of D/A converter 810 apply D/A conversion to I signal and Q signal without performing the interleaving operation. The conversion rate at this point is 792 Msps, and the Nyquist frequency is ½, or 396 MHz. In this case, symbol f2 is in a range of up to 264 MHz in terms of absolute value, and conversion to an analog signal is possible with a sufficient margin.

Upon the transmission of symbol f3, D/A converter 810 performs the interleaving operation as in the transmission of symbol f1. At this point, hopping complex filter 808 switches to the −f inhibition characteristics, inhibits the frequency components of symbol f1, and passes symbol f3.

As D/A converter 810 performs the interleaving operation, and hopping complex filter 808 is included, the conversion rate of D/A converter 810 can be reduced. Therefore, power consumption and circuit area of D/A converter 810 can be reduced.

### Fifth Exemplary Embodiment

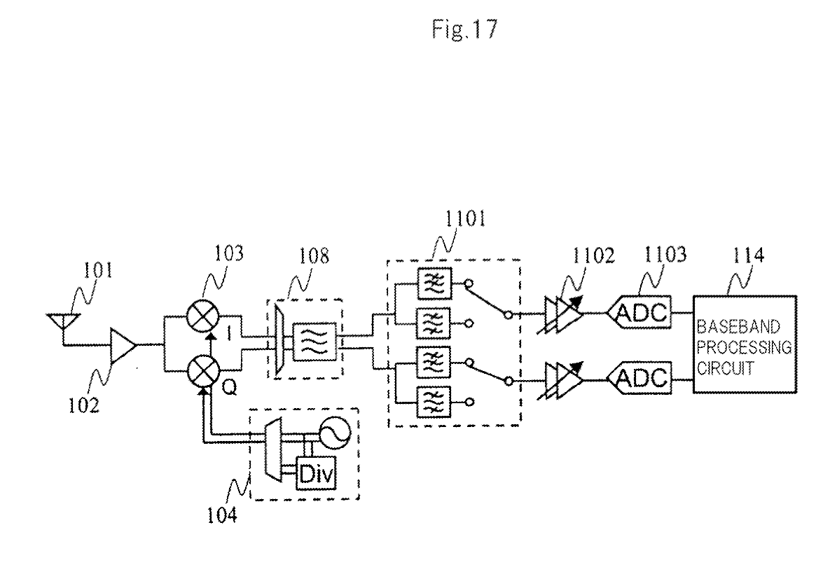

FIG. 17 is a block diagram showing a configuration of a UWB wireless communication apparatus of a fifth exemplary embodiment. As in the first to third exemplary embodiments, the fifth exemplary embodiment is an example of a receiver that receives a UWB signal.

As shown in FIG. 17, the receiver of the fifth exemplary embodiment comprises reception antenna 101, low noise amplifier (LNA) 102, first down converter 103, first local generator 104, hopping complex filter 108, and baseband processing circuit 114 shown in the first exemplary embodiment as well as selection filter 1101, variable gain amplifier 1102, and A/D converter 1103.

In the configuration of the receiver of the fifth exemplary embodiment, selection filter 1101 that can change the filter wave characteristics is connected to the latter stage of hopping complex filter 108, in place of the second down converter shown in the first exemplary embodiment. The configurations of reception antenna 101, low noise amplifier (LNA) 102, first down converter 103, first local generator 104, hopping complex filter 108, and baseband processing circuit 114 are the same as in the receiver shown in the first exemplary embodiment. Therefore, the description will not be repeated.

Upon the reception of symbol f1 and symbol f3, selection filter 1101 operates as a bandpass filter that passes the frequency of, for example, 264 to 792 MHz and that attenuates other frequencies.

Meanwhile, upon the reception of symbol f2, selection filter 1101 operates as a low-pass filter that passes the frequency of, for example, up to around 264 MHz and that attenuates other frequencies. Similar to hopping complex filter 108, the filter wave characteristics of selection filter 1101 are quickly switched in accordance with, for example, a control signal from baseband processing circuit 114, thus, in accordance with the hopping operation of the UWB signal.

As in the second exemplary embodiment, variable gain amplifier 1102 amplifies the frequency signal of, for example, up to about 792 MHz in which symbol f1 to symbol f3 pass through.

Although A/D converter 1103 of the exemplary embodiment applies A/D conversion to frequency signals of, for example, up to 792 MHz as in variable gain amplifier 1102, the conversion rate is set to, for example, 528 Msps. Therefore, the Nyquist frequency is set to 264 MHz.

Although this is usually a band necessary to convert only symbol f2 around DC, under sampling is applied to symbol f1 and symbol f3 with this conversion rate in the exemplary embodiment.

The exemplary embodiment operates as in the first exemplary embodiment up to hopping complex filter 108.

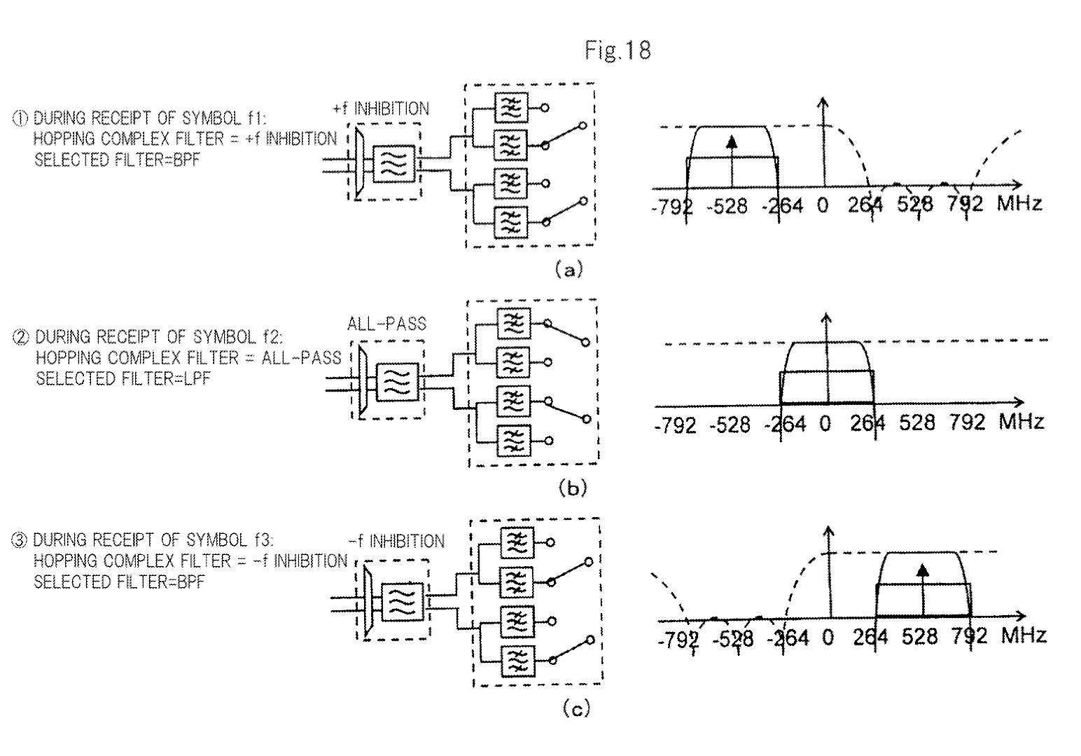

Upon the reception of symbol f1, selection filter 1101 operates as a bandpass filter (BPF) that passes the frequency components of symbol f1 as shown in FIG. 18(a) and that suppresses other signals and noise.

Variable gain amplifier 1102 amplifies the IF signal outputted from filter 1101 up to a required level in accordance with the dynamic range of A/D converter 1103 and outputs the IF signal to A/D converter 1103.

As described, A/D converter 1103 applies under sampling to symbol f1.

The reason that A/D converter 1103 can perform under sampling is that hopping complex filter 108 and filter 1101 cut out substantially only symbol f1.

Similarly, upon the reception of symbol f2, hopping complex filter 108 switches to the all-pass characteristics, and filter 1101 operates as a low-pass filter (LPF) to cut out symbol f2 (see FIG. 18(b)).

Symbol f2 is within the Nyquist frequency of A/D converter 1103, and A/D converter 1103 performs A/D conversion without problems.

Similarly, upon receipt of symbol f3, hopping complex filter 108 switches to the −f inhibition characteristics, and filter 1101 operates as a bandpass filter (BPF) that cuts out symbol f3 (see FIG. 18(c)).

Although symbol f3 is outside the Nyquist frequency of A/D converter 1103, A/D converter 1103 performs A/D conversion without problems, because hopping complex filter 108 and filter 1101 cut out substantially only symbol f3.

According to the exemplary embodiment, only a minimum conversion rate (528 Msps) required by A/D converter 113 to convert one symbol is necessary, and the circuit area and power consumption of A/D converter 1103 can be minimized.

In addition to the same advantages as the receivers of the first to third exemplary embodiments, the receiver of the fifth exemplary embodiment has an advantage in which the circuit area and power consumption of the entire receiver can be minimized.

Although examples in which the band group that comprises three bands have been described in the first to fifth exemplary embodiments, the number of bands forming the band group is not limited to three. As long as the frequency of the local signal is set to the center frequency of the band group, the same advantages can be obtained regardless of the number of bands forming the band group or regardless of whether the number is odd or even.

For example, if the band group comprises three (odd) bands, the frequency of the local signal can be set to the center frequency of the second band, as in the first to fifth exemplary embodiments. If the band group comprises four (even) bands, the frequency of the local signal can be set to the frequency between the second band and the third band.

According to the UWB wireless communication apparatus of the present invention, the conversion rates of the A/D converter and the D/A converter can be minimized by suppressing the image signal using the hopping complex filter. In this case, even if the frequency of the local signal is somewhat apart from the center frequency of the band group, as long as there is a collision of image signals, the excellent advantages of the present invention can be obtained by filtering the image signals using the hopping complex filter.

### Sixth Exemplary Embodiment

Although examples of configuration of the UWB wireless communication apparatus in which sequential hops between three bands have been illustrated in the first to fifth exemplary embodiments, there can be a communication system for simultaneously using bands to realize faster communication.

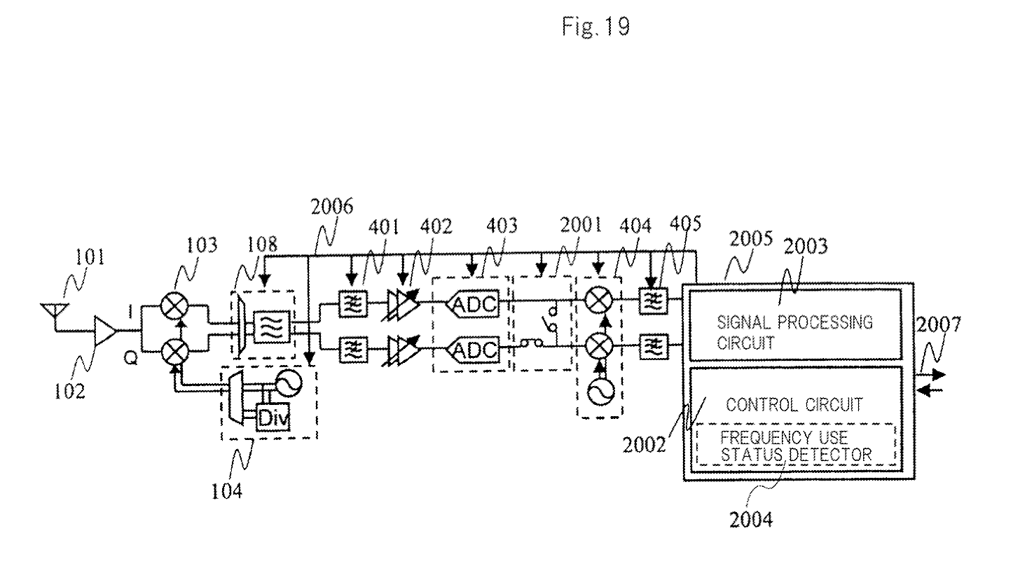

FIG. 19 is a block diagram showing a configuration of a UWB wireless communication apparatus of a sixth exemplary embodiment. FIG. 19 illustrates an example of a configuration of a UWB wireless communication apparatus that can handle both a communication system for sequentially hopping between bands and a communication system for simultaneously using bands.

The UWB wireless communication apparatus shown in FIG. 19 has a configuration in which the UWB wireless communication apparatus shown in FIG. 8 further comprises: switch 2001 for outputting output signals of two sets of A/D converters included in association with I signal and Q signal to the next stage or for outputting either an I signal or a Q signal; and controller 2005 capable of communicating with upper layers.

Controller 2005 comprises signal processing circuit 2003 that executes baseband signal processing and control circuit 2002 that controls the constituent elements included in the wireless communication apparatus.

Controller 2005 controls operations of hopping complex filter 108, local generator 104, low-pass filter 401, variable gain amplifier 402, A/D converter 403, switch 2001, second down converter (orthogonal modulator) 404, and second low-pass filter 405.

Specifically, controller 2005 changes the frequency of the local signals, controls the passband of hopping complex filter 108, changes the conversion rate of A/D converter 403, and turns off the power of the constituent elements to terminate the operations.

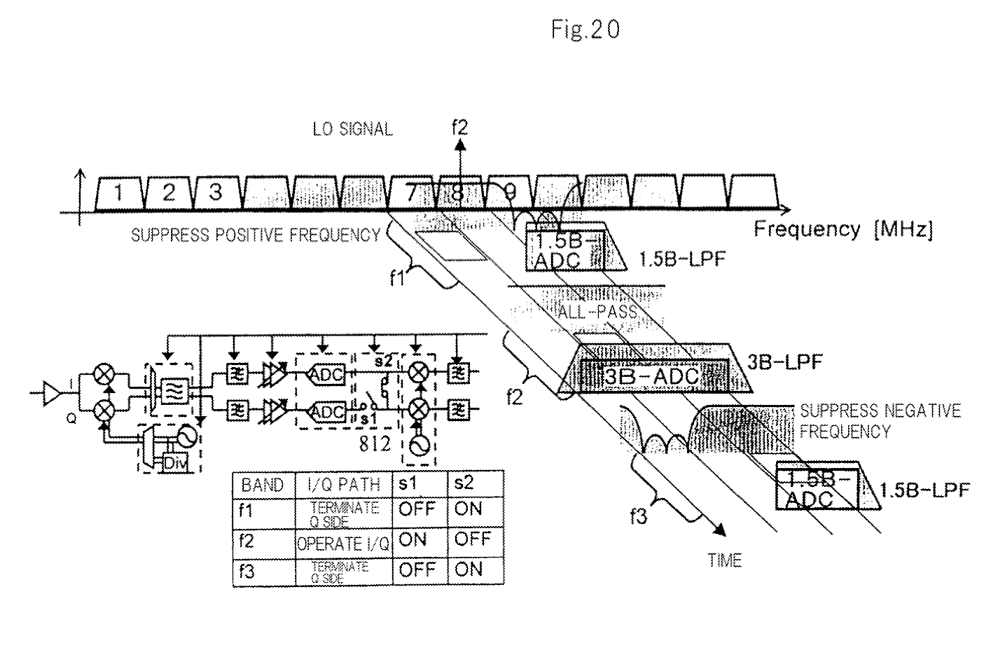

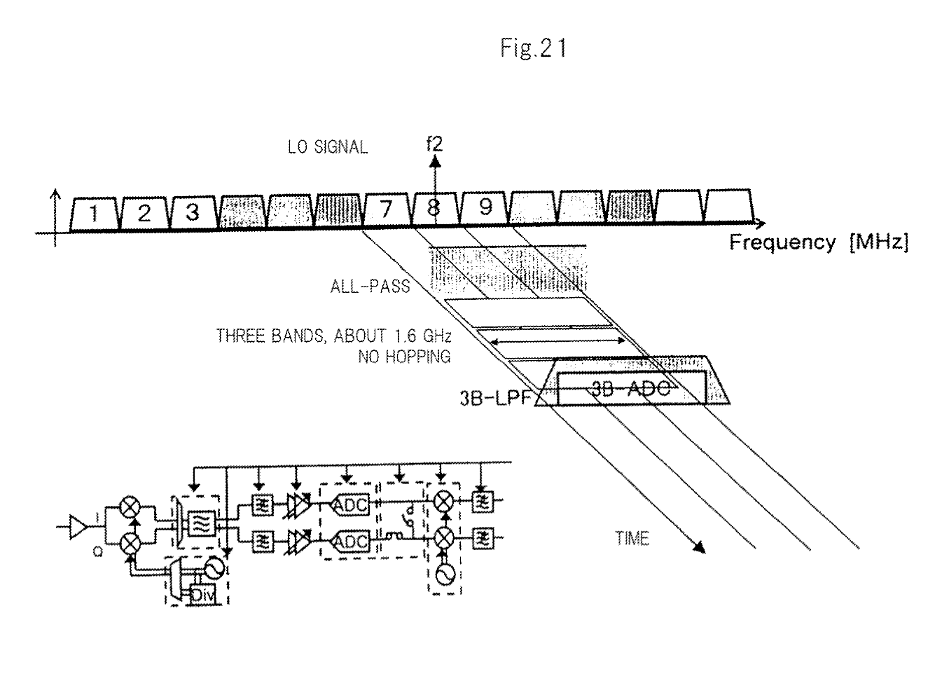

An operation of the sixth exemplary embodiment will be described with reference to FIGS. 20 and 21.

As described, in the hopping communication, the signals of symbols f1 to f3 can be sequentially cut out by quickly switching the characteristics of the hopping complex filter. This applies to the transmitter and the receiver.

As shown in FIG. 20, although the UWB wireless communication apparatus of the sixth exemplary embodiment operates in the same way as in the second exemplary embodiment (FIGS. 8, 9, 10, and 11), the bandwidth (band) of the A/D converter, the passband (band) of the low-pass filter, the operation of terminating I signal and Q signal, and the like are different.

In the UWB wireless communication apparatus of the exemplary embodiment, A/D converter 403 comprises a conversion rate covering all bands for hopping. For example, the UWB comprises an A/D converter capable of applying A/D conversion to signals in frequency bands of three bands. In the exemplary embodiment, the conversion rate of A/D converter 403 is 1584 Msps.

In the exemplary embodiment, the conversion rate of A/D converter 403 is not changed during hopping of symbols f1 to f3. However, in symbol f1 and symbol f3, the signals are in an actual area (real area) as a result of processing by hopping complex filter 108. Therefore, the operation of one of two A/D converters 403 for I signal and Q signal can be terminated.

When only one of A/D converters 403 is operated, an area of one side of a complex area (±792 MHz) is converted. Therefore, although the conversion rate is the same, the band that can be converted is ½ of the operation of both sides. More specifically, A/D converters 403 for I signal and Q signal can apply A/D conversion to the signal components of three bands. Therefore, one of A/D converters 403 can apply A/D conversion to the signal components of 1.5 bands.

The same applies to first low-pass filter 401. First low-pass filter 401 of the exemplary embodiment has frequency characteristics of passing frequency components of three bands in the complex area and has frequency characteristics of passing frequency characteristics of 1.5 bands in the real area. For example, the UWB has frequency characteristics of passing frequency components of ±792 MHz (three bands) in the complex area and has frequency characteristics of passing frequency components of 792 MHz (1.5 bands) in the real area.

The operation shown in FIG. 20 terminates the operation of the path for Q signal upon receipt of symbols f1 and f3, power consumption is reduced by that much.

Controller 2005 issues instructions to the components in accordance with hopping of symbols f1 to f3. For symbol f1, switch 2001 is set to a mode for passing either an I signal or a Q signal. For example, s1 shown in FIG. 20 is turned off, and s2 is turned on.

As a result, the output signal of A/D converter 403 for I signal is inputted to both inputs of second down converters 404 for I signal and Q signal of the next stage. At this point, A/D converter 403 for Q signal, variable gain amplifier 402 for Q signal, and first low-pass filter 401 for Q signal are not used and can be terminated. As a result, power consumption required in the operation of the path for Q signal can be reduced.

Next, controller 2005 sets symbol f2 upon switching from symbol f1 to symbol f2. Although the switching time is a short time, which is about 10 ns, the quickness included in hopping complex filter 108 and switch 2001 can handle it in the exemplary embodiment.

For symbol f2, switch 2001 is switched to a mode for passing both I signal and Q signal. For example, s1 shown in FIG. 20 is turned on, and s2 is turned off. In this case, the terminated operation of the path for Q signal is restarted, and processing is executed for I signal and Q signal.

For symbol f3, a similar operation as for symbol f1 is performed, except that the inhibition area of hopping complex filter 108 is set to a negative frequency (passband is set to a positive frequency).

A multiple band simultaneous operation for simultaneously using bands to transmit and receive data will be described next.

FIG. 21 illustrates an operation for simultaneously operating three bands.

As in the case shown in FIG. 20, the frequency of the local signal is set at the center of the band group, or in this case, at the center frequency of the frequency bands of the simultaneously operating bands. Controller 2005 controls hopping complex filter 108 to the all-pass characteristics.

First low-pass filter 401 and A/D converter 403 are controlled to correspond to frequency bands of three bands, and switch 2001 is controlled to be in a mode for passing both I signal and Q signal.

In the operation of the analog section, only the difference from the operation shown in FIG. 20 is that hopping complex filter 108 is set to the all-pass characteristics throughout all symbols.

In the present invention, due to the quickness of hopping complex filter 108, hopping complex filter 108 can quickly move from the mode shown in FIG. 20 to the mode shown in FIG. 21. The feature of the present invention, which is setting the frequency of the local signal at the center of the band group, in other words, at the center of the frequency range of the bands for use, allows fast movements between the modes.

This allows switching between one band communication and multiple band communication in the middle of consecutive symbols, such as by using one band for transmission and receipt of preamble and using multiple bands for transmission and receipt of payload.

This minimizes power consumption, and this is also preferable from the perspective of transmitting information using a minimum band for transmission and receipt of preamble including little information and using a maximum band for transmission and receipt of payload including much information.

Generally, in the transmission of information, there are constituent elements that consume power proportional to the amount of information and constituent elements that consume power not proportional to the amount of information. For example, the former is a logic circuit that processes information, and the latter is a low noise amplifier, a mixer, a local generator, or the like included in the RF.

To reduce the rate of consumed power without being proportional to the information as in the latter case, a remarkable advantage can be obtained by multiple band communication in which information is included as much as possible and the information is transmitted at once. This is based on the fact that the operations of the low noise amplifier, the mixer, the local generator, and the like do not have to be changed even if multiple bands are selected, in other words, power consumption of the low noise amplifier, mixer, and the local generator do not change.

From another perspective, it is significant that free bands can be quickly used, even if only slightly, to efficiently use free bands in a cognitive wireless communication environment.

There are two methods for applying an FFT process to the baseband signals of multiple bands.

A first method is to include FFT bits of three bands. For example, although the number of bits is 128b in a normal FFT process of UWB communication of one band, an FFT process of three bands can be executed at once by setting the number of bits to 384b, which is three times as many.

A second method is a method of carrying out the FFT process by dividing the bands into predetermined units.

Dividing the bands into each band is preferable because FFT blocks having the same configuration as one band communication can be used. Examples of the method of dividing the bands into each band include a method of using two sets of SSB mixers, or four multipliers, and a method of using complex computation.

In the method of using two sets of SSB mixers, second down converter 404 comprises four multipliers.

A signal inputted to an I input of second converter 404 is inputted to two multipliers. A second local signal of cosωt is inputted to one of the multipliers, and a second local signal of sinωt is inputted to the other multiplier. The second local signals are multiplied by the signal inputted to the I input. In this case, ω is set to the center frequency of symbol f1 and symbol f3 and is set to 528 MHz in the UWB.

For example, the same computation is performed for a signal of a Q input. The result of adding the cosine multiplication result of the I input and the cosine multiplication result of the Q input is set as an I output of the second down converter, and the subtraction result of the sine multiplication result of the I input and the sine multiplication result of the Q input is set as a Q input of a second orthogonal converter. In this way, only the positive frequency of the complex area can be down-converted, or only the negative frequency can be down-converted. This is an operation of independently extracting the frequency of symbol f1 and the frequency of symbol f3, which are in a relationship of image frequencies, without overlapping.

Second down converter 404 can comprise a complex computation and two mixers.

The image frequency can be suppressed if the same digital processing as in hopping complex filter 108 is applied to the 1/Q input of second down converter 404. As described, since a rotation operator of phase 90° is used, the complex computation for removing the image frequency can be realized by, for example, replacing a function equivalent to a capacitor with a differential operator. The differential operation in digital processing is equivalent to the deviation between data of time-series data. Two mixers (SSB mixers) can process the signal, from which the image frequency is removed, to perform down conversion while removing the image frequency.

Second low-pass filter 405 is used to remove the signal components of symbol f1 and symbol f3 existing on the high frequency side upon the extraction of the signal of symbol f2. Upon the extraction of symbol f2, it can be designed to avoid performing frequency conversion by providing DC as a local signal to second down converter 404 or by preventing the passage through second down converter 404.

Upon the extraction of symbol f1 or f3, although the frequency conversion is performed by the method, the signal of symbol f1 around-DC moves to the high frequency side of symbol f1 or f3. Therefore, second low-pass filter 405 is used to remove symbol f1 or f3.

Switching between a one band operation and a multiple band simultaneous operation of fast hopping and the like is controlled by, for example, a MAC (media access control) layer to baseband processing circuit 114.

Controller 2005 shown in FIG. 19 may only have a function as a baseband processing circuit or may also have a function of a MAC layer. In the MAC layer, the traffic of data is monitored, and the transmission rate of PHY (physical layer) is determined according to an instruction from a higher layer.

Multiple bands are occupied in the multiple bands simultaneous operation. Therefore, whether to move to the multiple band operation is determined under the condition in which wireless communication of another Piconet or another standard is not performed in the bands. To realize this, it is preferable that the frequency bandwidth use status can be acquired in real time. It is preferable to collectively apply A/D conversion to three bands in super frame period and the like to acquire the use status of three bands. Since some power is consumed in such a function, the function may be included only in a host computer in an environment including, for example, a host computer and a device terminal.

Furthermore, in the multiple band simultaneous operation, more power than in the one band operation is consumed. Therefore, in a battery driven apparatus (such as a device terminal) and the like, in which the limitation of power consumption is strict, whether to move to the multiple band simultaneous operation may be determined in accordance with the capacity of battery and the like.

In a simple communication between terminal apparatuses, a packet may not be filled with meaningful data. In that case, it is preferable to select the one band operation. On the other hand, if the traffic increases and the packet is filled with effective data, the power required to transmit the same amount of data can be reduced by selecting the multiple band operation to transmit the data in a short time. The selection between the one band operation and the multiple bands operation may be determined according to the amount of transmission data.

In the wireless communication, C/N (ratio of carrier and noise) of communication varies depending on the distance between terminals for communication, radio frequency bandwidth use status in the surroundings areas, noise level, arrangement of antenna, condition in space (for example, fading and multipath), and the like. For example, the operation mode to be used may be selected by analyzing the amount of C/N in each band from the data obtained by collectively applying A/D conversion to three bands.

Specifically, assuming that the C/N of symbol f1 is poor due to the condition in space, use status of radio frequency, and the like, the multiple band communication or one band communication without the band can be used if it is determined that the use efficiency of power does not improve by the use of the band, even if there is no interference from other stations.

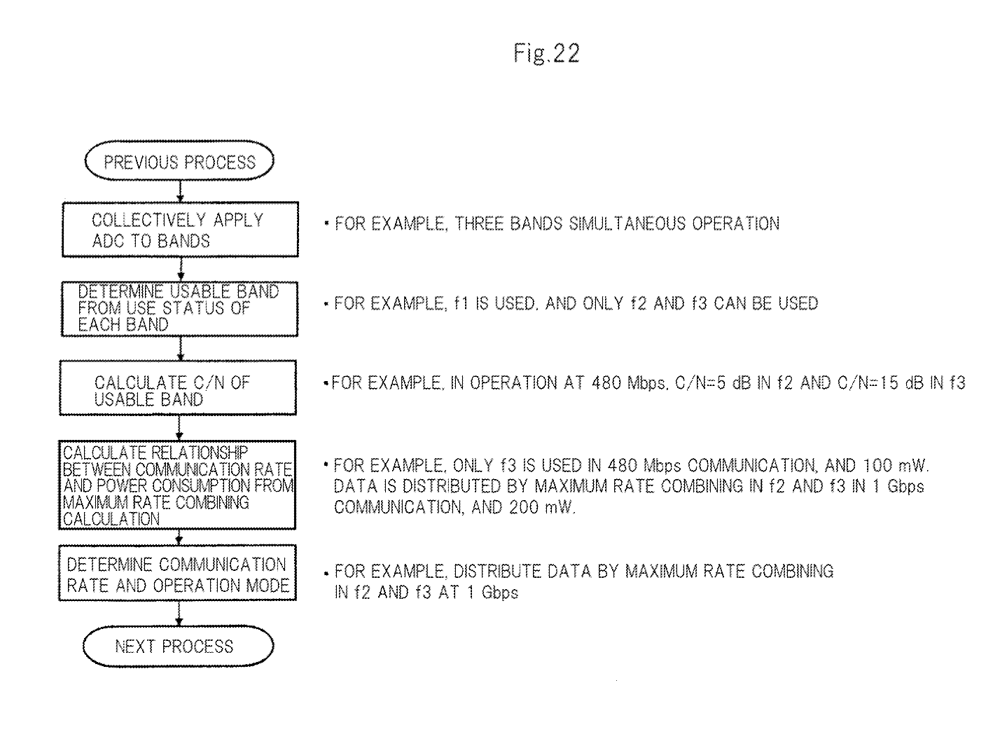

More specifically, as shown in FIG. 22, the operation mode can be determined in accordance with a process of collectively applying A/D conversion to multiple bands, a process of determining usable bands from the use status of the bands, a process of calculating C/N of the usable bands, a process of calculating the communication rate and power consumption relationship from maximum ratio combining calculation, and a process of determining the communication rate and the operation mode.

The maximum ratio combining is used in space diversity including antennas or in MIMO (Multi-Input Multi-Output) communication. When the used space and the used frequency are determined, the maximum communication rate obtained under the communication environment can be calculated.

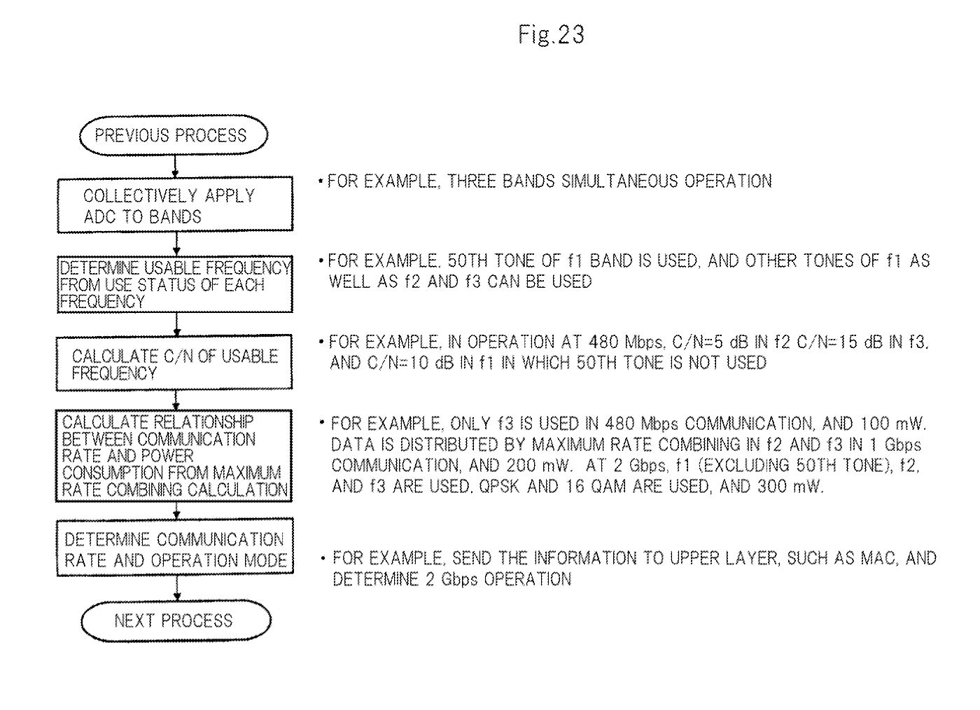

More specifically, as shown in FIG. 23, it is assumed that a specific frequency, or for example, a 50th tone of an OFDM symbol of symbol f1, is used in another communication (such as narrowband communication).

In this case, the communication rate and the operation mode are determined to avoid a specific tone of a specific band based on the same procedure as the process shown FIG. 22. Examples of detecting a used tone include a method of collectively applying the FFT process to the band outputs from the A/D converter and a method of sequentially applying the FFT process to each band to check the condition of each tone.

In the calculation of C/N, although the C/N may be calculated for each tone or may be calculated for each band or multiple tones, the calculations are common in that the tones are controlled.

In three bands simultaneous communication, signals simultaneously exist in three bands of symbols f1 to f3, and setting the hopping complex filter to the all-pass allows transmission and reception by use of three bands. To simultaneously use three bands, a reception apparatus requires an A/D converter (D/A converter in a transmission apparatus) that can cover three or more bands.

For example, in a UWB with a bandwidth of 528 MHz, the band of three bands is 1584 MHz (±792 MHz as a band in a complex area), which is three times as large as 528 MHz. To convert the band, an A/D converter and a D/A converter of 1584 Msps is needed. There is a frequency of the local signal at the center of three bands, and the band of three bands (1584 MHz) exists at ±792 MHz around the frequency of the local signal. Therefore, the Nyquist frequency can be 792 MHz.

In the A/D converter and the D/A converter in the hopping communication and the three bands simultaneous communication, the conversion rates may be the same or may be different.

The minimum required conversion rate in three band simultaneous communication is a conversion rate (1584 Msps) equivalent to the frequency band of three bands (for example, 1584 MHz). With such a wide conversion rate, a signal of hopping communication can be handled. Therefore, the same conversion rate can be applied to the hopping communication.

The conversion rate in the hopping communication can be lowered to reduce power consumption in the hopping communication. As described in the first and fourth exemplary embodiments, conversion rates (for example, 528 Msps and 1056 Msps) that can convert one band (for example, 528 MHz) and two bands (for example, 1056 MHz) may be included in the hopping communication. More specifically, power consumption in the hopping communication can be reduced by switching the conversion rate, such as a conversion rate of three bands (for example, 1584 Msps) for the three band simultaneous communication and a conversion rate of one band or two bands (for example, 528 Msps or 1056 Msps) in the hopping communication.

The foregoing description also applies to the transmitter.

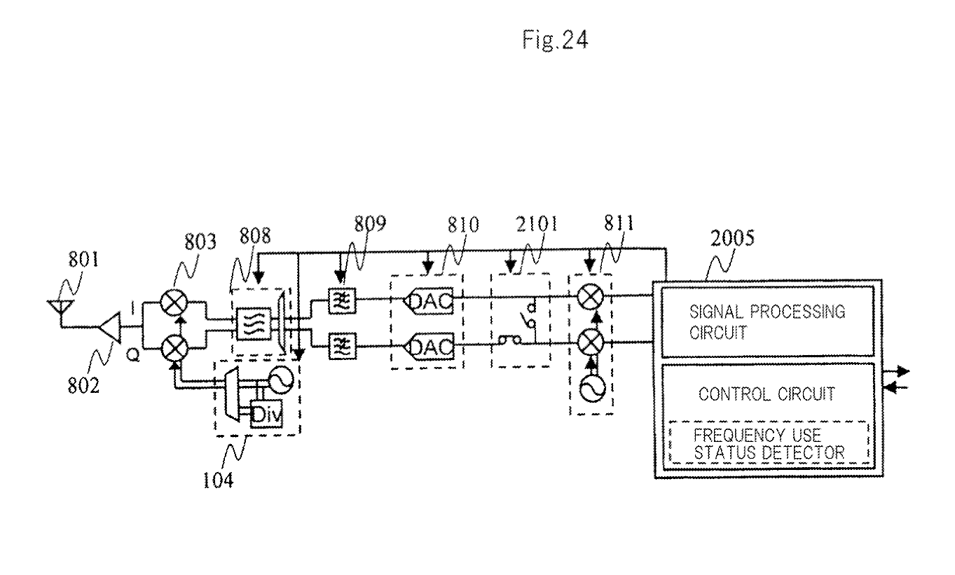

FIG. 24 is an example of the transmitter that performs the one band operation and the multiple band operation.

As shown in FIG. 24, the transmitter of the sixth exemplary embodiment has a configuration of pausing one of the paths for I signal and Q signal, as in the configuration shown in FIG. 19. Controller 2005 acts on the constituent elements of the path for I signal or the path for Q signal to disconnect the power supply or to disconnect the supply of bias current to thereby terminate one of the paths. As described in FIG. 16, the transmitter can comprise switch 2101 and cause the D/A converter to perform the interleaving operation to supply the output to one of the paths for I signal and Q signal.

Although FIG. 24 illustrates an example of using hopping complex filter 808 shown in FIG. 5, a configuration shown in FIG. 6 may be used for hopping complex filter 808 as necessary according to a target operation and the like.

Among the descriptions related to the receiver, the one band operation and the multiple band operation can be realized by changing the A/D converter to the D/A converter and by processing the signal from the baseband processing circuit to the transmission antenna. For example, the operation can be expressed by replacing the A/D converter shown in FIG. 20 or 21 by the D/A converter and reversing the direction of the filter and the amplifier.

### Seventh Exemplary Embodiment

The present invention can attain maximum advantages by the hopping complex filter by further expanding the one band operation and the multiple band operation.

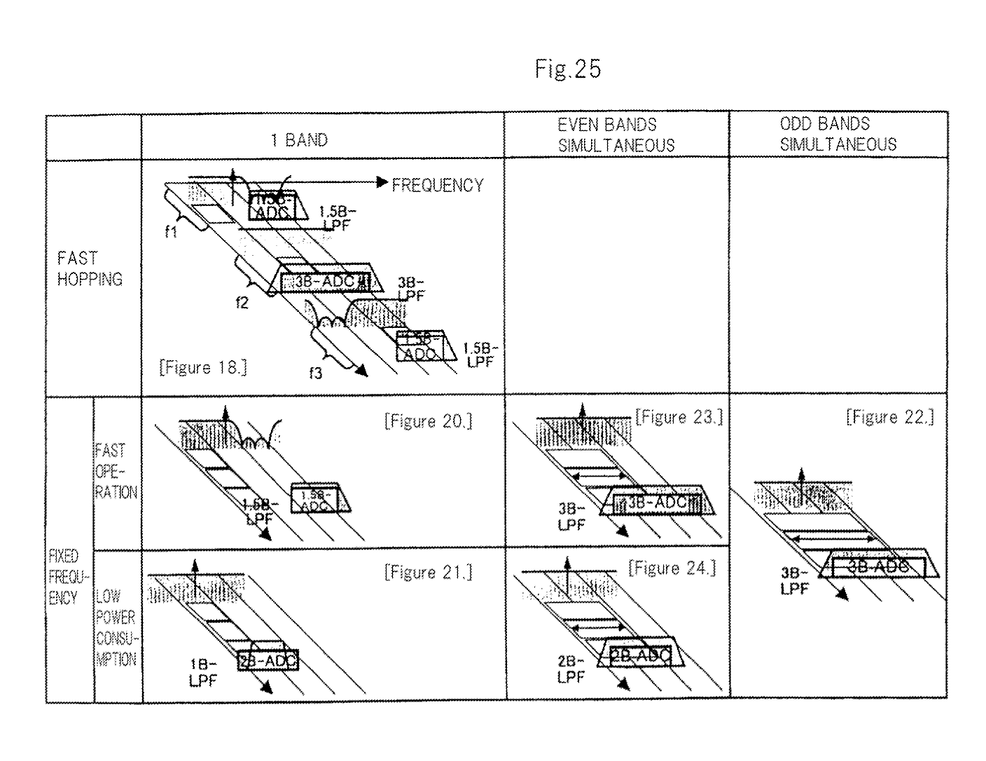

FIG. 25 shows an example of a wireless communication apparatus using a hopping complex filter capable of corresponding to various modes.

The chart shown in FIG. 25 illustrates a form of use of the frequency of a one band operation, even bands simultaneous operation, and odd bands simultaneous operation in the horizontal direction and shows fast hopping and frequency fixation operation in the vertical direction.

In the frequency fixation operation, an operation focusing on a fast operation and an operation focusing on low power are illustrated.

Usually, the wireless communication apparatus includes an error correction (FEC) function. A reduction in C/N at a specific frequency or a reduction in C/N at specific time can be handled by making the information redundant in the time direction and in the frequency direction based on the error correction function.

Not only the time direction, but also the frequency direction is made redundant in fast hopping. In the frequency fixed communication, there is redundancy in the time direction and between tones in the band. As for the redundancy of frequency, the frequency of the fast hopping that can use separate frequencies can be made more redundant.

The frequency fixed communication includes a fast operation and a low power consumption operation, and in general, the fast operation may be focused in the host terminal apparatus that coordinates Piconet. The low power consumption operation may be focused in the device terminal apparatus with a large limitation in power consumption.

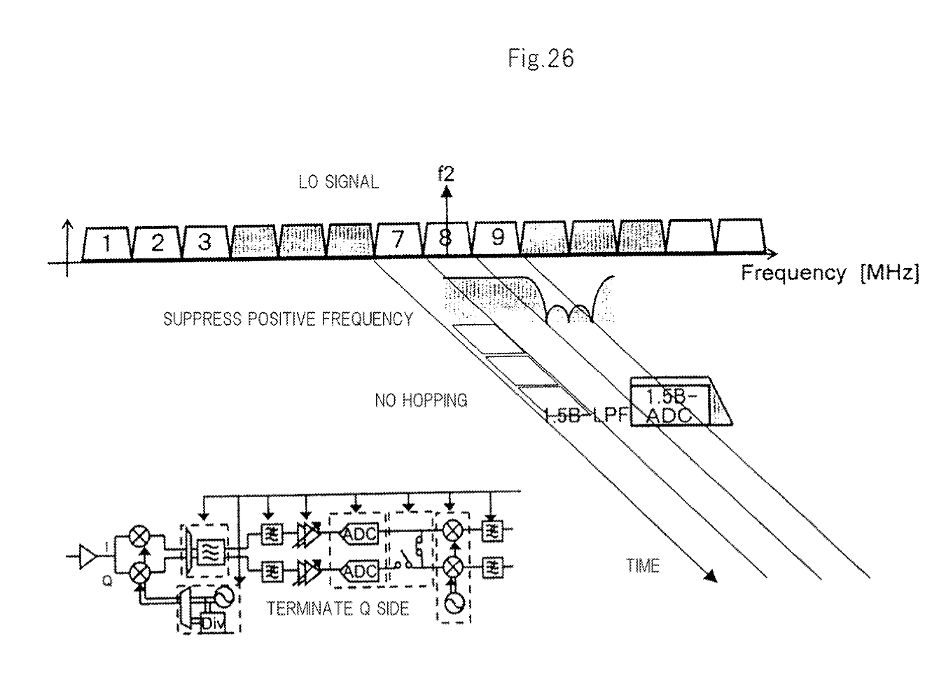

FIG. 26 shows an example of configuration of one band communication, frequency fixed communication, and fast operation.

As in the hopping operation and the three bands simultaneous operation shown in FIGS. 20 and 21, the frequency of the local signal is set at the center of the band group. Furthermore, the complex filter is fixed at positive frequency inhibition in the example shown in FIG. 26. Furthermore, the A/D converter is set to a 1.5 bandwidth, and the low-pass filter is also set to the 1.5 bandwidth.

As described in the hopping operation of the sixth exemplary embodiment, this is realized by terminating the operation of the path for Q signal.

In the example, the only difference from the operations shown in FIGS. 20 and 21 is the setting of the hopping complex filter. A quick movement can be made from the one band communication and the frequency fixed communication operation shown in FIG. 26 to the hopping operation shown in FIG. 20 or to the three bands simultaneous operation shown in FIG. 21. A movement between the operations shown in FIGS. 20, 21, and 26 can also be made quickly.

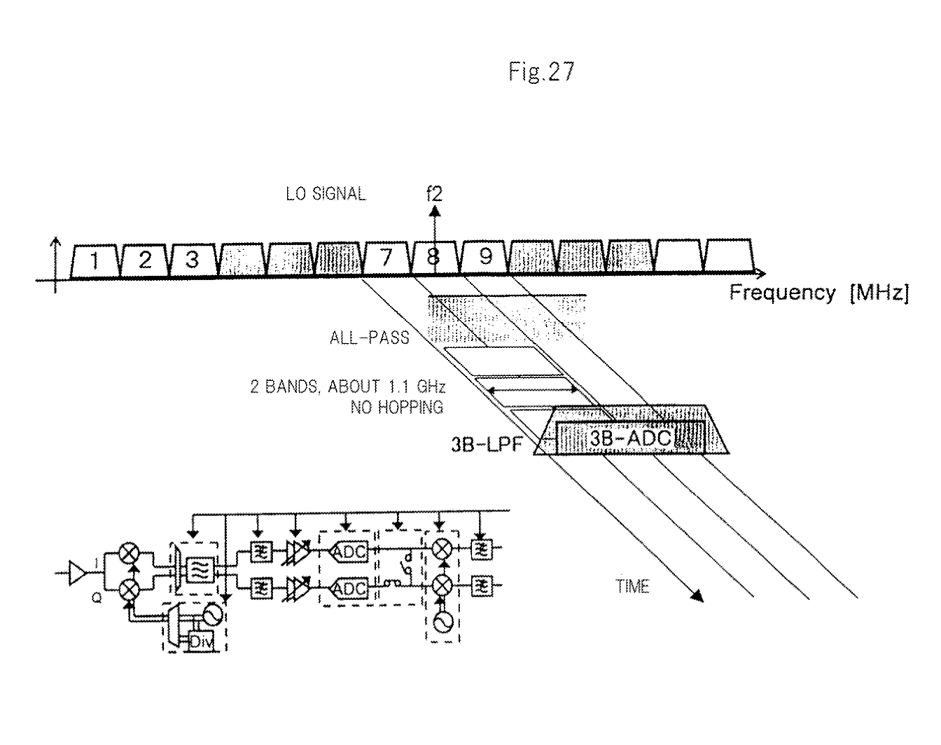

FIG. 27 shows an example of even bands simultaneous communication, frequency fixation, and fast operation.

Only the hopping complex filter is changed in this case, too. The operations shown in FIGS. 20, 21, and 26 and the operation shown in FIG. 27 can be quickly switched.

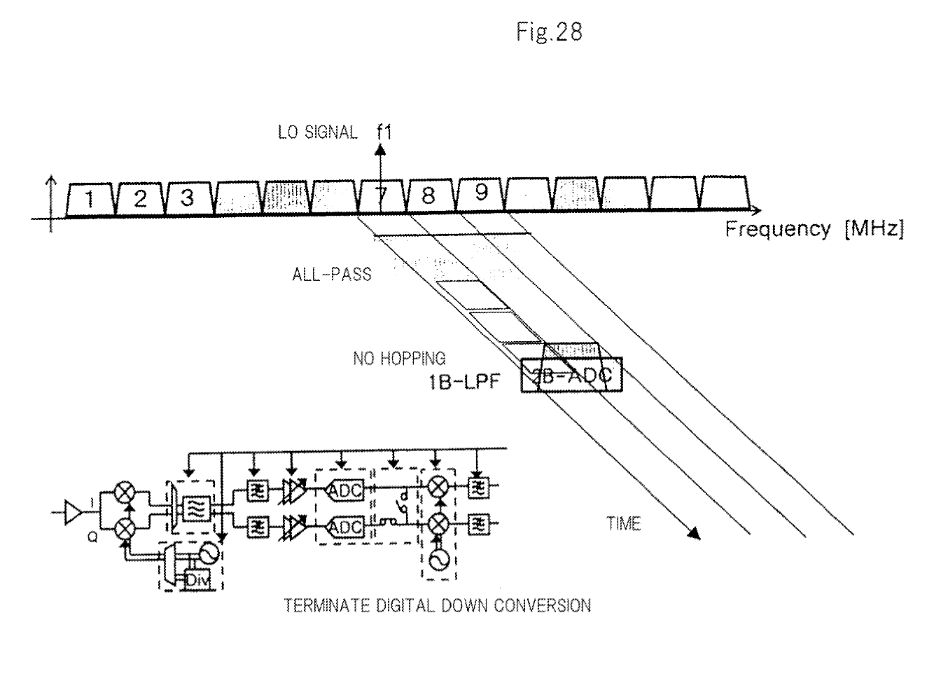

FIG. 28 shows an example of a configuration of frequency fixation, low power consumption, and one band.

In the example shown in FIG. 28, the frequency of the local signal is set to the center of symbol f1. The hopping complex filter is set to the all-pass characteristics, the A/D converter is set to two bandwidths, and the low-pass filter is set to one bandwidth. This can reduce the conversion rate of the A/D converter, and power consumption can be reduced by that much.

Furthermore, the down converter (up converter in the transmitter) in the digital area can also be terminated, and power consumption can be reduced by that much.

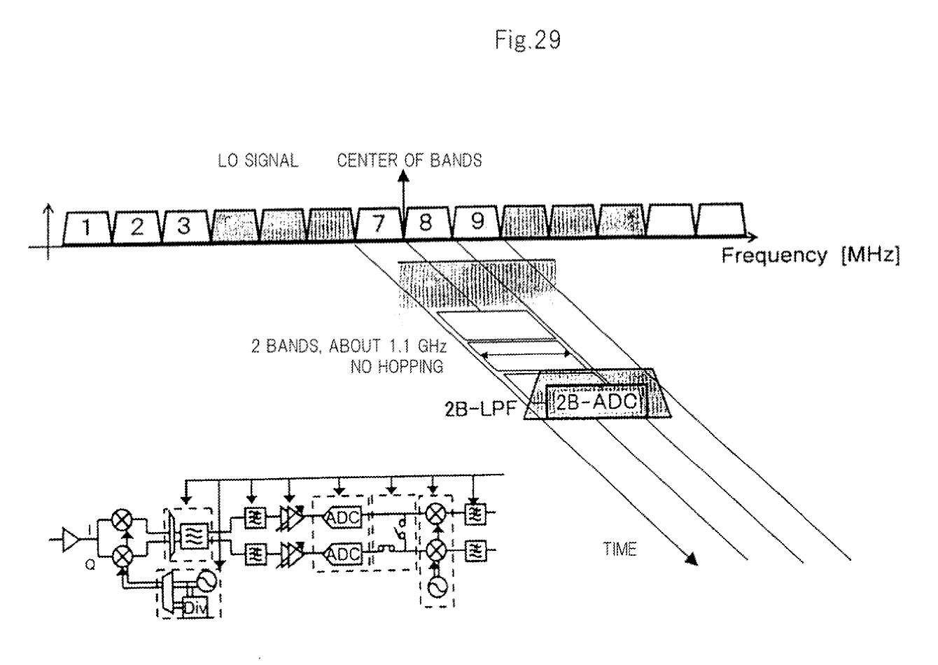

FIG. 29 shows an example of a configuration of frequency fixation, low power consumption, and even band simultaneous.

In the example shown in FIG. 29, the frequency of the local signal is set between symbol f1 and symbol f2. In this case, the frequency of the local signal is set at the center of the frequency range from symbol f1 to symbol f2 that are simultaneously operated. The hopping complex filter is set to the all-pass characteristics, the A/D converter is set to two bandwidths, and the low-pass filter is set to two bandwidths. As a result, the conversion rate of the A/D converter can be reduced compared to the operation shown in FIG. 27, and power consumption can be reduced by that much.

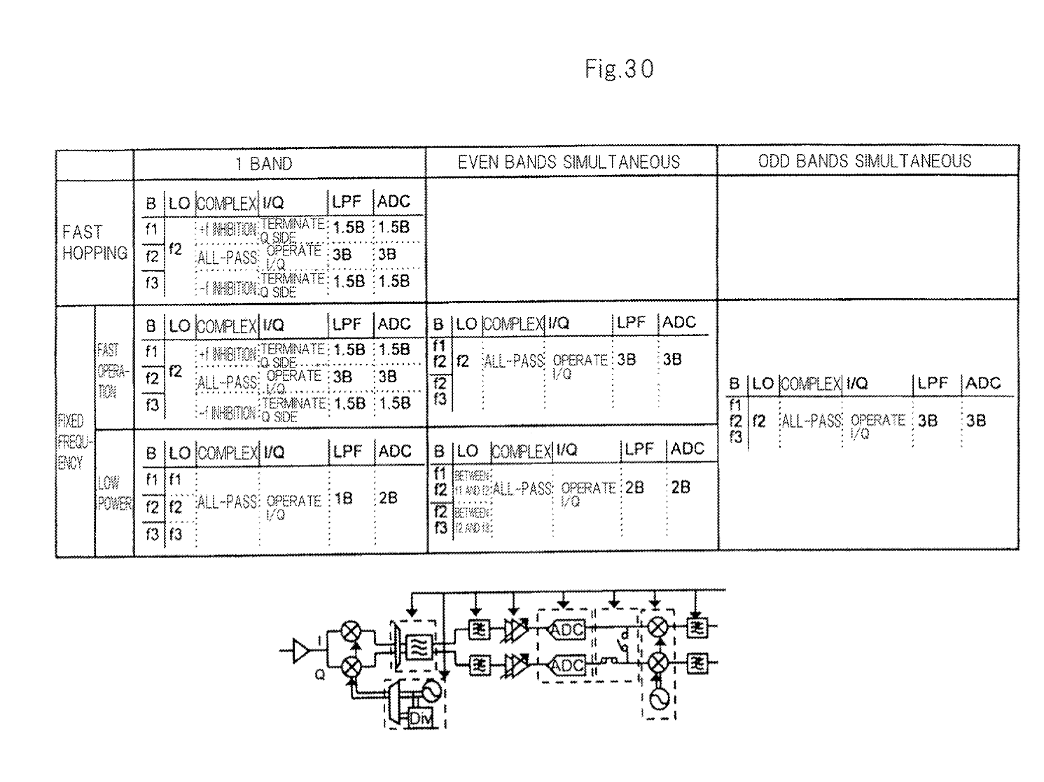

FIG. 30 is a chart collectively showing settings of the wireless communication apparatus in the execution of the modes shown in FIG. 25.

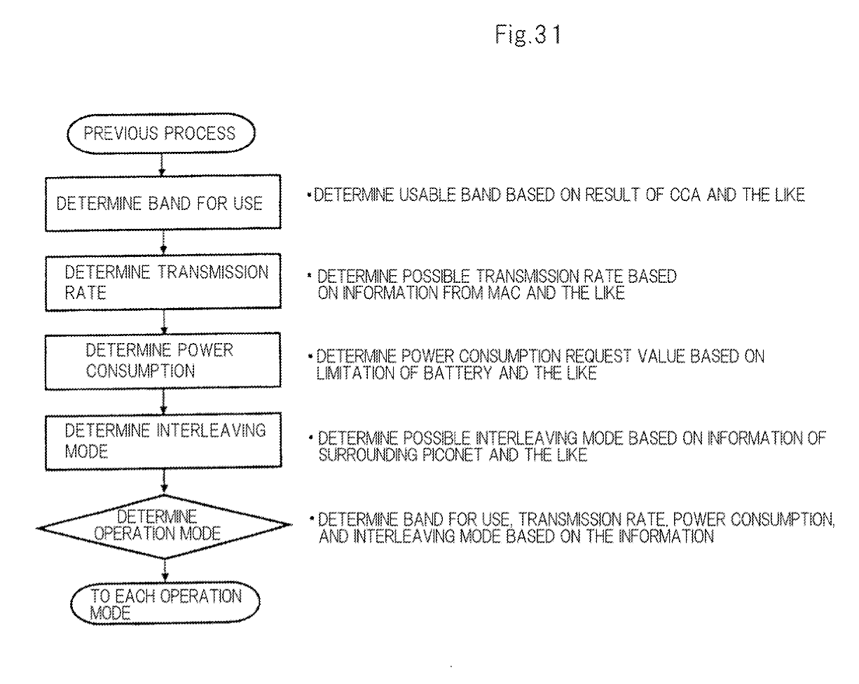

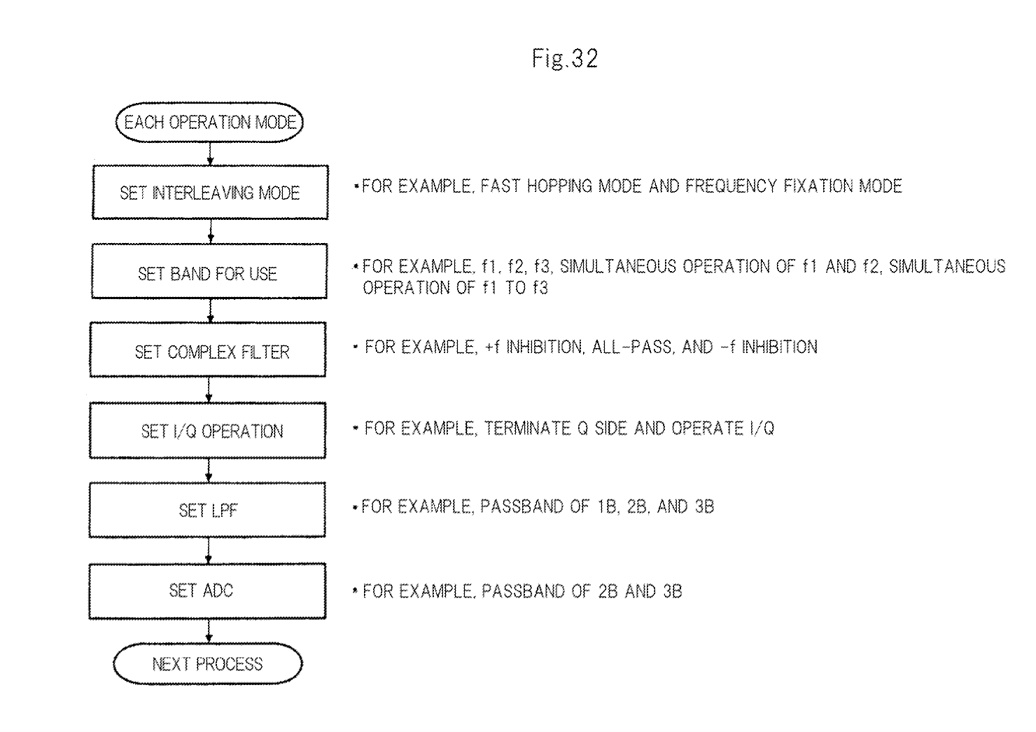

In the modes of the wireless communication apparatus, the band for use, the transmission rate, power consumption, and the interleaving mode are determined according to the procedure shown in FIG. 31 to determine the operation mode. To move to the operation mode, the interleaving mode, the band for use, the complex filter, the I/Q operation, the low-pass filter, and the A/D converter are set as shown in FIG. 30 according to the procedure shown in FIG. 32.

Controller 2005 can control the hopping complex filter, the local generator, the low-pass filter, the A/D converter, the down converter, the D/A converter, the selector, and the like to switch the mode of the wireless communication apparatus.

In the present invention, such control is possible based on the fast and flexible operation of the complex filter.

### <Sequential Circuit, Program, And Storage Medium>

The controller of the present invention described above can be realized by, for example, a sequential circuit formed by a logic circuit or a computer operated in accordance with a program. The sequential circuit may be a circuit, for which operations are defined in advance, or a circuit, in which the logic or the order can be changed. Although a micro controller, a micro processor, a DSP (digital signal processor), a personal computer, a work station, and the like may be used as the computer, the present invention is not limited to these.

As described above, the quickness of the hopping complex filter, which is a feature of the present invention, can reduce power consumption and the circuit area based on the configuration in which only one frequency of the local signal is used. The controller controls the A/D converter, the I/Q path, the LPF, and the like to handle various modes. The multiple band simultaneous operation allows obtaining a high throughput and handling a change in traffic, and the use efficiency of frequency improves.

According to the present invention, power consumption can be minimized in accordance with the requested transmission rate. Conventionally, there is a method of terminating either an I path or a Q path to reduce power consumption. However, in the present invention, the passband of the hopping complex filter is quickly changed in accordance with frequency hopping, and accordingly, one of the I/Q paths can be terminated in a certain hopping symbol.

Furthermore, according to the present invention, the same circuit can handle the multiple band simultaneous operation and the fast hopping operation. Moreover, the LO frequency used in the multiple band simultaneous operation and the fast hopping operation can be the same, and quick switching between the operations is possible. The reason is that although the complex filter is switched between three conditions (+f inhibition, all-pass, and −f inhibition) in the fast hopping, it can be handled by using one of the conditions (all-pass) in the multiple band simultaneous operation. Sharing of circuit resources can minimize the chip area.

Although the present invention has been described with reference to the exemplary embodiments, the present invention is not limited to the exemplary embodiments. Various changes that can be understood by those skilled in the art may be made for the configurations and details of the present invention within the scope of the present invention.

This application claims the benefit of priority based on Japanese Patent Application No. 2008-115389 filed Apr. 25, 2008, the entire disclosure of which is hereby incorporated by reference.

1-16. (canceled)

17. A wireless communication apparatus that is used in wireless communication and that comprises a band group formed by bands formed by a predetermined frequency band, said wireless communication apparatus handling both wireless communication for hopping the bands in said band group by a predetermined sequence and wireless communication for simultaneously using the bands in said band group, said wireless communication apparatus comprising:
a local generator that generates a local signal equivalent to a center frequency of said band group;
a first down converter that uses the local signal generated by said local generator to down-convert a wireless signal in said band group; and
a hopping complex filter that treats said down-converted signal as an input to change a passband.

18. The wireless communication apparatus according to claim 17, further comprising
an A/D converter that converts a signal outputted from said hopping complex filter to a digital signal and that can control a conversion rate.

19. The wireless communication apparatus according to claim 18, further comprising
a first filter that limits a band of a signal inputted to said A/D converter and that can control the passband.

20. The wireless communication apparatus according to claim 19, further comprising
a controller that controls the passband of said hopping complex filter, the conversion rate of said A/D converter, and the passband of said first filter.

21. The wireless communication apparatus according to claim 20, wherein
said local generator
has a configuration of shifting the frequency of said local signal in the band group, and
said controller
controls the frequency of the local signal generated by said local generator.

22. The wireless communication apparatus according to claim 21, wherein
said controller
controls a characteristic of said hopping complex filter, the conversion rate of said A/D converter, the passband of said first filter, and the frequency of the local signal generated by said local generator in accordance with a frequency use status in said band group.

23. The wireless communication apparatus according to claim 21, wherein
said controller
controls the characteristic of said hopping complex filter, the conversion rate of said A/D converter, the passband of said first filter, and the frequency of the local signal generated by said local generator in accordance with a requested transmission rate.

24. A wireless communication apparatus that is used in wireless communication and that comprises a band group formed by bands formed by a predetermined frequency band, said wireless communication apparatus handling both wireless communication for hopping the bands in said band group by a predetermined sequence and wireless communication for simultaneously using the bands in said band group, said wireless communication apparatus comprising:
a local generator that generates a local signal equivalent to a center frequency of said band group;
a first up converter that uses the local signal generated by said local generator to up-convert a wireless signal in said band group; and
a hopping complex filter that treats said up-converted signal as an input to change a passband.

25. The wireless communication apparatus according to claim 24, further comprising
a D/A converter that supplies a signal to said hopping complex filter and that can control a conversion rate.

26. The wireless communication apparatus according to claim 25, further comprising
a second filter that limits a band of a signal outputted from said D/A converter and that can control the passband.

27. The wireless communication apparatus according to claim 26, characterized by further comprising
a controller that controls the passband of said hopping complex filter, the conversion rate of said D/A converter, and the passband of said second filter.

28. The wireless communication apparatus according to claim 27, wherein
said local generator has a configuration of shifting the frequency of said local signal in the band group, and
said controller
controls the local frequency of said local generator.

29. The wireless communication apparatus according to claim 28, wherein
said controller
controls a characteristic of said hopping complex filter, the conversion rate of said D/A converter, the passband of said first filter, and the frequency of the local signal generated by said local generator in accordance with a frequency use status in said band group.

30. The wireless communication apparatus according to claim 28, wherein
said controller
controls the characteristic of said hopping complex filter; the conversion rate of said D/A converter, the passband of said first filter, and the frequency of the local signal generated by said local generator in accordance with a requested transmission rate.

31. The wireless communication apparatus according to claim 20, wherein
said A/D converter
collectively applies A/D conversion to the bands, and
said controller
determines a usable band from the use status of each band,
calculates C/N of the usable band,
calculates a relationship between a communication rate and power consumption, and
determines the communication rate and an operation mode.

32. The wireless communication apparatus according to claim 20, wherein
said A/D converter
collectively applies A/D conversion to the bands, and
said controller
determines a usable tone from the use status of each tone,
calculates C/N of the usable tone,
calculates a relationship between a communication rate and power consumption, and
determines the communication rate and an operation mode.
